(19) United States
(12) Patent Application Publication
(10) Pub. No.: US 2022/0014722 A1
(43) Pub. Date: Jan. 13, 2022

(54) IMAGE PROCESSING DEVICE, IMAGE PROCESSING METHOD, AND PROGRAM

(71) Applicant: SONY CORPORATION, Tokyo (JP)

(72) Inventors: Hisako SUGANO, Kanagawa (JP); Yoichi HIROTA, Kanagawa (JP); Hiroaki TAKAHASHI, Tokyo (JP)

(73) Assignee: SONY CORPORATION, Tokyo (JP)

(21) Appl. No.: 17/291,752

(22) PCT Filed: Nov. 29, 2019
(86) PCT No.: PCT/JP2019/046729

§ 371 Date: May 6, 2021

(30) Foreign Application Priority Data
Dec. 12, 2018 (JP) 2018-232692

(51) Int. Cl. H04N 13/111; G06T 17/20; G06T 13/40; G06T 19/20; G06F 3/0481

(52) U.S. Cl. CPC H04N 13/111; G06T 17/20; G06F 3/04815; G06T 19/20; G06T 13/40

(57) ABSTRACT

An image processing device includes circuitry configured to generate a stroboscopic model including 3D models of a subject arranged in a three-dimensional space, the 3D models being generated from a plurality of viewpoint images captured from a plurality of viewpoints at a plurality of times, and set camerawork of a virtual camera in accordance with a state of the 3D models arranged in the stroboscopic model, the camerawork being set for capturing the stroboscopic model by the virtual camera to generate a stroboscopic image.

### CROSS REFERENCE TO RELATED APPLICATIONS

This application claims the benefit of Japanese Priority Patent Application JP 2018-232692 filed on Dec. 12, 2018, the entire contents of which are incorporated herein by reference.

### TECHNICAL FIELD

The present technology relates to an image processing device, an image processing method, and a program, and particularly relates to an image processing device, an image processing method, and a program that enable easy production of video content of a stroboscopic image, for example.

### BACKGROUND ART

A method of generating a stroboscopic image showing a subject (image) captured at a plurality of times, has been proposed (e.g., refer to PTL 1). Because the stroboscopic image shows the subject at the plurality of times, the motion or the trajectory of the subject can be easily grasped.

### CITATION LIST

### Patent Literature

[PTL 1]

JP 2007-259477A

### SUMMARY

### Technical Problem

According to PTL 1, however, although the motion or the trajectory of the subject viewed in one direction can be grasped, a change to an arbitrary viewpoint a user desires is not allowed.

The present technology has been made in consideration of such a situation, and is to enable easy production of video content of a stroboscopic image.

### Solution to Problem

An image processing device according to an embodiment of the present technology includes circuitry configured to generate a stroboscopic model including 3D models of a subject are arranged in a three-dimensional space, the 3D models being generated from a plurality of viewpoint images captured from a plurality of viewpoints at a plurality of times, and set camerawork of a virtual camera in accordance with a state of the 3D models arranged in the stroboscopic model, the camerawork being set for capturing the stroboscopic model by the virtual camera to generate a stroboscopic image. A program according to an embodiment of the present technology causes a computer to function as such an image processing device.

An image processing method according to an embodiment of the present technology, includes generating a stroboscopic model including 3D models of a subject arranged in a three-dimensional space, the 3D models being generated from a plurality of viewpoint images captured from a plurality of viewpoints at a plurality of times, and setting camerawork of a virtual camera in accordance with a state of the 3D models arranged in the stroboscopic model, the camerawork being set for capturing the stroboscopic model by the virtual camera to generate a stroboscopic image.

In any of an image processing device, an image processing method, and a program according to embodiments of the present technology, a stroboscopic model including 3D models of a subject arranged in a three-dimensional space, is generated, the 3D models being generated from a plurality of viewpoint images captured from a plurality of viewpoints at a plurality of times. Then, camerawork of a virtual camera is set in accordance with a state of the 3D models arranged in the stroboscopic model, the camerawork being set for capturing the stroboscopic model by the virtual camera to generate a stroboscopic image.

Note that the image processing device and a display device each may be an independent device or may be an internal block included in one device.

Furthermore, the program can be provided by transmission through a transmission medium or by recording onto a non-transitory computer-readable recording medium.

### BRIEF DESCRIPTION OF DRAWINGS

FIG. 1 is a block diagram of a configuration according to one embodiment of an image processing system to which the present technology has been applied.

FIG. 2 is a block diagram of a configuration of an image processing unit 13.

FIG. 3 is a flowchart for describing a free viewpoint image display processing of displaying a 3D stroboscopic image as a free viewpoint image, to be performed by the image processing system.

FIG. 4 is an illustration of an unnatural 3D stroboscopic image.

FIG. 5 is an illustration of an natural 3D stroboscopic image.

FIG. 6 is an illustration of frames of viewpoint image in a stroboscopic section.

FIG. 7 is an illustration of generation of a stroboscopic model with frames between time t1 and time t9 as the stroboscopic section.

FIG. 8 is an illustration of display of a 3D stroboscopic image generated by capturing of the stroboscopic model by a virtual camera.

FIG. 9 is an illustration of a user interface (UI) for selection of 3D models to be arranged finally in the stroboscopic model.

FIG. 10 is an illustration of a normal model and a sparse model.

FIG. 11 is an illustration of a UI for selection of effect processing to be performed to the 3D models arranged in the stroboscopic model.

FIG. 12 is an illustration of a stroboscopic model before the effect processing and a stroboscopic model after the effect processing.

FIG. 13 is an illustration for describing 3D models to be subjected to the effect processing in an effect processing unit 23, in the stroboscopic model.

FIG. 14 is a table for describing examples of the effect processing.

FIG. 15 is a block diagram of a configuration of a camerawork setting unit 24.

FIG. 16 is an illustration of a first example in which a position setting unit 61 sets a capturing start position and a capturing finish position in accordance with model distribution.

FIG. 17 is an illustration of a second example in which the position setting unit 61 sets a capturing start position and a capturing finish position in accordance with model distribution.

FIG. 18 is an illustration of a third example in which the position setting unit 61 sets a capturing start position and a capturing finish position in accordance with model distribution.

FIG. 19 is an illustration of generation of default camerawork by a camerawork generation unit 62.

FIG. 20 is an illustration for describing change of camerawork corresponding to an operation of a user.

FIG. 21 is an illustration of change of the camerawork corresponding to an operation of the user.

FIG. 22 is an illustration for describing generation of the camerawork in a case where a subject shown in a viewpoint image is an animal, such as a human.

FIG. 23 is an illustration for describing selection of 3D models to be arranged in the stroboscopic model, corresponding to the state of the 3D models arranged in the stroboscopic model to be captured by the virtual camera.

FIG. 24 is an illustration for describing setting of the capturing start position and the capturing finish position for connection of an actual image before and after the 3D stroboscopic image.

FIG. 25 is an illustration of overlaying of overlay images onto the stroboscopic model.

FIG. 26 is a block diagram of a configuration according to one embodiment of a computer to which the present technology has been applied.

### DESCRIPTION OF EMBODIMENTS

<Image Processing System to which Embodiments of the Present Technology has been Applied>

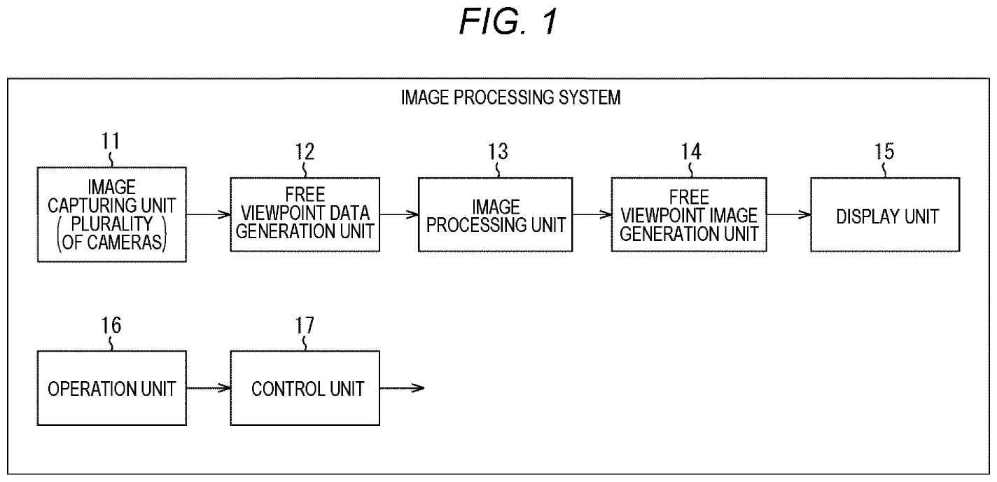

FIG. 1 is a block diagram of a configuration according to one embodiment of an image processing system to which the present technology has been applied.

In the image processing system of FIG. 1, a free viewpoint image corresponding to the degree of vision at viewing of a subject in a three-dimensional space from an arbitrary viewpoint, is generated with free viewpoint data generated from a live-action image. Then, the free viewpoint image is displayed on an arbitrary display device. Here, one viewpoint selected as the arbitrary viewpoint is referred to as an imaginary viewpoint (virtual viewpoint) in the present specification.

The image processing system of FIG. 1 includes an image capturing unit 11, a free viewpoint data generation unit 12, an image processing unit 13, a free viewpoint image generation unit 14, a display unit 15, an operation unit 16, and a control unit 17.

The image capturing unit 11 including at least a plurality of cameras, captures a subject from a plurality of viewpoints. For example, the plurality of cameras included in the image capturing unit 11 is arranged around the subject. Each camera captures the subject from a viewpoint as the position at which the camera is arranged. A two-dimensional (2D) image captured by each camera from the position of the camera, namely, viewpoint images (video) at the plurality of viewpoints including the 2D images captured from the plurality of viewpoints are supplied per frame from the image capturing unit 11 to the free viewpoint data generation unit 12.

Here, the image capturing unit 11 can be provided with a plurality of ranging devices in addition to the plurality of cameras. The ranging devices can be arranged at positions identical to those of the cameras (viewpoints) or can be arranged at positions different from those of the cameras. The ranging devices each measure the distance from the position at which the ranging device is arranged (viewpoint) to the subject, to generate a depth image including a 2D image having, as a pixel value, depth that is information regarding the distance. The depth image is supplied from the image capturing unit 11 to the free viewpoint data generation unit 12.

Note that, in a case where the image capturing unit 11 is provided with no ranging device, measurement of the distance to the subject, based on the principle of triangulation with the viewpoint images at two viewpoints from the viewpoint images at the plurality of viewpoints, enables generation of a depth image.

The free viewpoint data generation unit 12 generates free viewpoint data of a 3D image per frame from the viewpoint images at the plurality of viewpoints and the depth images from the image capturing unit 11.

Here, the free viewpoint data is data of the 3D image enabling generation of a free viewpoint image. As the free viewpoint data, for example, a set of the viewpoint images at the plurality of viewpoints and the depth images from the image capturing unit 11, can be directly adopted. Furthermore, as the free viewpoint data, a 3D model (3D data including the 3D model, a background image, and the like) or a set of 2D images at a plurality of viewpoints and depth images, can be adopted as another example. The 3D model can be generated from the set of the viewpoint images at the plurality of viewpoints and the depth images or the set of 2D images at a plurality of viewpoints and depth images. Thus, in a broad sense, the set of the viewpoint images at the plurality of viewpoints and the depth images or the set of the 2D images at the plurality of viewpoints and the depth images can be regarded as the 3D model.

For adoption of the set of the viewpoint images at the plurality of viewpoints and the depth images from the image capturing unit 11 as the free viewpoint data, the free viewpoint data generation unit 12 supplies the image processing unit 13 with the set of the viewpoint images at the plurality of viewpoints and the depth images from the image capturing unit 11 as the free viewpoint data.

For adoption of the 3D model as the free viewpoint data, the free viewpoint data generation unit 12 performs modeling with, for example, the Visual Hull, with the viewpoint images at the plurality of viewpoints and the depth images at the plurality of viewpoints from the image capturing unit 11, to generate the 3D model of the subject shown in the viewpoint image. Then, the free viewpoint data generation unit 12 supplies the image processing unit 13 with the 3D model (3D data including the 3D model) as the free viewpoint data. Note that, in a case where the viewpoint of a depth image from the image capturing unit 11 is different from the viewpoint of a viewpoint image from the image capturing unit 11, the free viewpoint data generation unit 12 can generate a depth image at the viewpoint of the viewpoint image from the image capturing unit 11 with the depth images at the plurality of viewpoints from the image capturing unit 11.

For the adoption of the set of the 2D images at the plurality of viewpoints and the depth images as the free viewpoint data, as described above, the free viewpoint data generation unit 12 generates the 3D model of the subject shown in the viewpoint image, and generates a set of 2D images including the 3D model viewed from a plurality of viewpoints (may be identical to or different from those of the cameras included in the image capturing unit 11) and depth images. Then, the free viewpoint data generation unit 12 supplies the image processing unit 13 with the set of the 2D images at the plurality of viewpoints and the depth images, generated from the 3D model, as the free viewpoint data.

For simplification of description, unless otherwise specified, as the free viewpoint data, the 3D model (3D data including the 3D model) is adopted below.

Note that, adoption of the set of the 2D images at the plurality of viewpoints and the depth images generated from the 3D model as the free viewpoint data, enables reduction of the data volume of the free viewpoint data in comparison to adoption of the 3D model. WO 2017/082076A previously proposed by the present applicant, describes the technology of generating a set of 2D images at a plurality of viewpoints and depth images from a 3D model and transmitting the set. For generation of the set of the 2D images at the plurality of viewpoints and the depth images from the 3D model, the set of the 2D images at the plurality of viewpoints and the depth images can be encoded by a coding method for 2D images, such as multiview and depth video coding (MVCD), advanced video coding (AVC), or high efficiency video coding (HEVC).

Here, the 3D model (representation mode thereof) mainly includes a model called View Independent (hereinafter, also referred to as a VI model) and a model called View Dependent (hereinafter, also referred to as a VD model).

The VD model is the 3D model in which a 3D geometric model including information regarding a three-dimensional shape is separated from information regarding an image to be texture. In the VD model, the image to be texture is mapped on the 3D geometric model (texture mapping), resulting in addition in color. The VD model enables, for example, representation of the degree of reflection on the surface of the subject varying depending on a (virtual) viewpoint.

The VI model is the 3D model in which polygons and points, as constituent elements of a 3D geometric model, have color information. Examples of the VI model include a colored point cloud and a set of a 3D geometric model and a UV map as information regarding the color of the 3D geometric model. The VI model allows observation of the respective colors of the polygons and the points even when viewed from any (virtual) viewpoint.

With the 3D model as the free viewpoint data of the 3D image from the free viewpoint data generation unit 12, for example, the image processing unit 13 generates a stroboscopic model in which the 3D models of the identical subject at a plurality of frames (times) of viewpoint image are arranged in the three-dimensional space captured by the image capturing unit 11, and sets camerawork for capturing of the stroboscopic model by a virtual camera.

The camerawork of the virtual camera is information regarding, at capturing by the virtual camera, the entire work of the capturing (procedure). For example, the camerawork of the virtual camera includes the position (capturing position) and the attitude (capturing attitude) (capturing direction) of the virtual camera, camera parameters such as magnification in zooming, and the like. The capturing position of the virtual camera can be expressed by, for example, coordinates in the xyz coordinate system as the world coordinate system. The capturing attitude of the virtual camera can be expressed by, for example, the angle of rotation around each axis in the xyz coordinate system. Here, the virtual camera corresponds to a viewpoint used in a case where a two-dimensional image from an arbitrary viewpoint is generated to the 3D model of the subject arranged in the three-dimensional space. Because the two-dimensional image can be generated finally as if captured by a camera arranged at the viewpoint, the description corresponding to a virtual viewpoint is referred to as the virtual camera in the present specification. The camerawork means movement of the viewpoint for generation of the two-dimensional image. Because the image can be generated as if captured by a camera moving, the camerawork is referred to as the camerawork of the virtual camera in the present specification.

After generating the stroboscopic model, as necessary, the image processing unit 13 performs, for example, effect processing to the 3D models arranged in the stroboscopic model, and then supplies the free viewpoint data as the stroboscopic model and the camerawork to the free viewpoint image generation unit 14.

Here, in a case where the free viewpoint data includes the viewpoint images at the plurality of viewpoints and the depth images or the 2D images at the plurality of viewpoints and the depth images, the image processing unit 13 performs modeling to each of the plurality of frames used for generation of the stroboscopic model, so that the 3D models of the subject shown in the plurality of frames can be individually generated. Then, the 3D model in each of the plurality of frames is arranged (combined) in the three-dimensional space as the background, so that the stroboscopic model can be generated. Alternatively, silhouette images of the subject shown in the plurality of frames are combined, and modeling is performed with a combined silhouette image acquired by the combination, resulting in generation of a so-called combined 3D model in which the respective 3D models of the subject shown in the plurality of frames are combined. Then, the combined 3D model is arranged in the three-dimensional space as the background, so that the stroboscopic model can be generated.

Moreover, with, as the criterial 3D model, for example, the 3D model at the latest time or the 3D model specified in accordance with an operation of a user from the 3D models arranged in the stroboscopic model, the image processing unit 13 can perform the effect processing to the 3D models in either the past or the future or in both of the past and the future with respect to the criterial 3D model.

Furthermore, without the effect processing in accordance with, for example, an operation of the user, the image processing unit 13 can supply the free viewpoint image generation unit 14 with the free viewpoint data as the stroboscopic model. Moreover, without generation of the stroboscopic model in accordance with, for example, an operation of the user, the image processing unit 13 can supply the free viewpoint image generation unit 14 with the free viewpoint data from the free viewpoint data generation unit 12.

The free viewpoint image generation unit 14 generates, as the free viewpoint image (data thereof), video of a 3D stroboscopic image including a 2D image (herein, a set of a 2D image for left eye and a 2D image for right eye inclusive) acquired by capturing of the stroboscopic model from the image processing unit 13 by the virtual camera, corresponding to the camerawork from the image processing unit 13. In other words, the free viewpoint image generation unit 14 renders the image including the stroboscopic model viewed from the capturing position included in the camerawork from the image processing unit 13, to generate the video of the 3D stroboscopic image as the free viewpoint image. Here, the stroboscopic model to be captured by the virtual camera may be a stroboscopic model subjected to texture mapping or may be a stroboscopic model not subjected to texture mapping.

Here, a stroboscopic image is an image showing at least one identical subject (image) captured at a plurality of times. The stroboscopic image showing the subject shown in a 2D image, is also referred to as a 2D stroboscopic image. The 2D image showing the 3D model of the subject, namely, the 2D image including the stroboscopic model viewed from a predetermined viewpoint, is also referred to as a 3D stroboscopic image. The free viewpoint image generation unit 14 generates the 3D stroboscopic image.

The free viewpoint image generation unit 14 supplies the 3D stroboscopic image to the display unit 15.

The display unit 15 including, for example, a 2D head-mounted display, a 2D monitor, a 3D head-mounted display, or a 3D monitor, displays the video of the 3D stroboscopic image as the free viewpoint image from the free viewpoint image generation unit 14. The 3D head-mounted display or the 3D monitor is, for example, a display device that displays a 2D image for left eye and a 2D image for right eye to achieve stereoscopic view.

The operation unit 16 supplies an operation signal corresponding to an operation of the user, to the control unit 17. Note that, for example, use of a touch panel enables the operation unit 16 to be integrally formed with the display unit 15.

The control unit 17 controls each block included in the image processing system. Furthermore, the control unit 17 performs various types of processing in accordance with the operation signal from the operation unit 16, namely, the operation of the user to the operation unit 16.

Note that the image processing system can include a server client system including, for example, a client and a cloud server. In this case, the cloud server can be provided with part or all of the free viewpoint data generation unit 12, the image processing unit 13, and the free viewpoint image generation unit 14. The client can be provided with the display unit 15 and the rest of the free viewpoint data generation unit 12, the image processing unit 13, and the free viewpoint image generation unit 14. The image capturing unit 11 can be arranged at an arbitrary location. For example, the viewpoint images output by the image capturing unit 11 can be transmitted to the free viewpoint data generation unit 12.

Furthermore, part or all of the free viewpoint data generation unit 12, the image processing unit 13, the free viewpoint image generation unit 14, the display unit 15, the operation unit 16, and the control unit 17 can be achieved by an application program of, for example, a smartphone.

The image processing system having the configuration described above, enables capturing of various sports, such as soccer, rugby, baseball, wrestling, boxing, judo, golf, tennis, and gymnastics, as the viewpoint image, and generation of the stroboscopic model in which 3D models of a predetermined subject, such as a particular player, are arranged. In this case, the 3D stroboscopic image generated from the stroboscopic model in which the 3D models of the particular player are arranged, can be used for sport analysis, such as an analysis of exercise of the particular player. A target for capturing of the viewpoint image in the image processing system, is not limited to the sports described above.

<Configuration of Image Processing Unit 13>

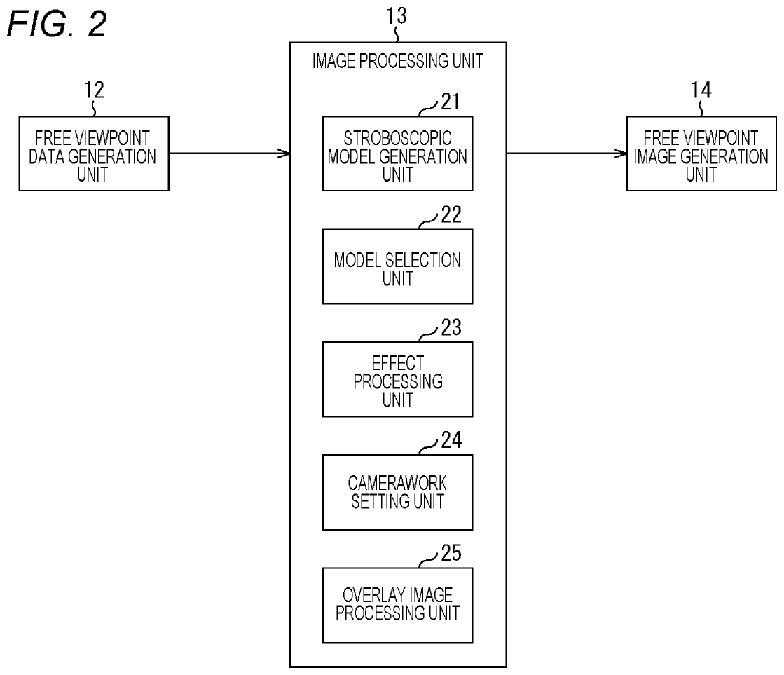

FIG. 2 is a block diagram of a configuration of the image processing unit 13 of FIG. 1.

In FIG. 2, the image processing unit 13 includes a stroboscopic model generation unit 21, a model selection unit 22, an effect processing unit 23, a camerawork setting unit 24, and an overlay image processing unit 25.

With the 3D model as the free viewpoint data of the 3D image from the free viewpoint data generation unit 12, the stroboscopic model generation unit 21 generates the stroboscopic model in which the 3D models of the identical subject in the plurality of frames of viewpoint image are arranged in the three-dimensional space.

The model selection unit 22 selects 3D models to be arranged finally in the stroboscopic model, for example, in accordance with an operation of the user (to operation unit 16), and generates the stroboscopic model in which the 3D models are arranged.

The effect processing unit 23 performs the effect processing to the 3D models arranged in the stroboscopic model, for example, in accordance with an operation of the user.

The camerawork setting unit 24 sets the camerawork of the virtual camera for generation of the 3D stroboscopic image by capturing of the stroboscopic model by the virtual camera, namely, for example, the capturing position and the capturing attitude (capturing direction) of the virtual camera and camera parameters, such as magnification in zooming, in accordance with the state of the 3D models arranged in the stroboscopic model.

In accordance with an operation of the user, the overlay image processing unit 25 overlays, for example, a line, text, a figure, or a stamp including a 2D image or a 3D image, as an overlay image to be overlaid on the stroboscopic model, onto the stroboscopic model.

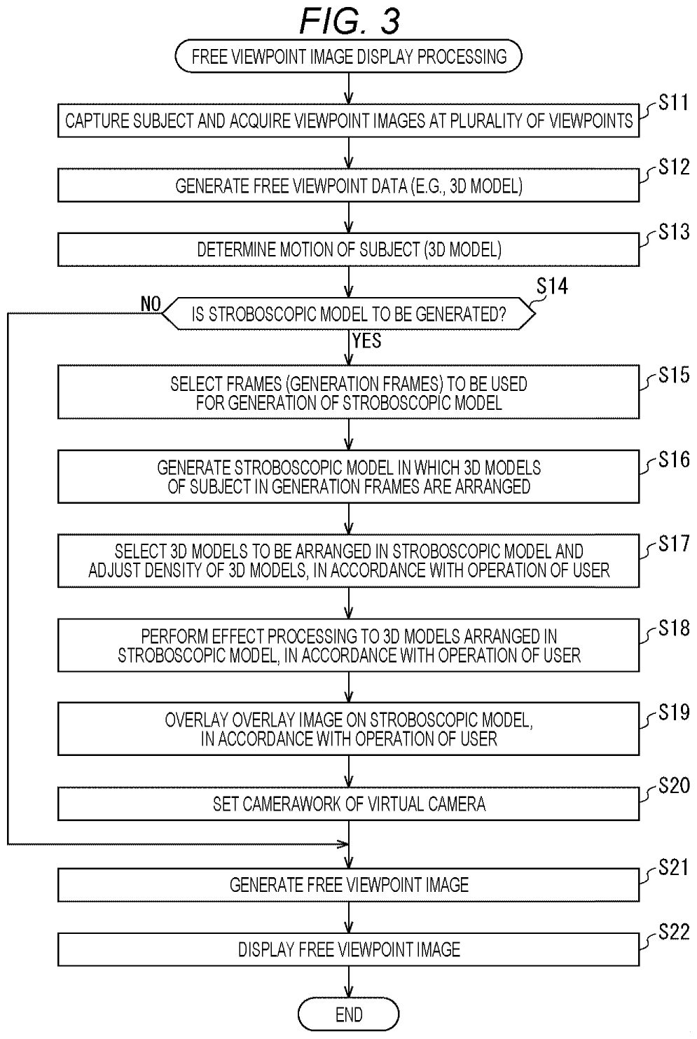

FIG. 3 is a flowchart for describing free viewpoint image display processing of displaying the 3D stroboscopic image as the free viewpoint image, to be performed by the image processing system of FIG. 1.

In the free viewpoint image display processing, at step S11, the image capturing unit 11 captures a subject from the plurality of viewpoints, and acquires the viewpoint images at the plurality of viewpoints and the depth images per frame. The image capturing unit 11 supplies the free viewpoint data generation unit 12 with the viewpoint images at the plurality of viewpoints and the depth images, and the processing proceeds from step S11 to step S12.

At step S12, with the viewpoint images at the plurality of viewpoints and the depth images from the image capturing unit 11, the free viewpoint data generation unit 12 performs modeling of the subject shown in the viewpoint image to generate, for example, the 3D model of the subject as the free viewpoint data, per frame. The free viewpoint data generation unit 12 supplies the image processing unit 13 with the 3D model of the subject (3D data including the 3D model and the background image) as the free viewpoint data, and the processing proceeds to step S13.

At step S13, in the image processing unit 13 (FIG. 2), the stroboscopic model generation unit 21 determines the motion of the subject that is the 3D model as the free viewpoint data from the free viewpoint data generation unit 12, and the processing proceeds to step S14.

At step S14, the stroboscopic model generation unit 21 determines whether to generate the stroboscopic model.

Here, the determination of whether the stroboscopic model is to be generated at step S14 is performed, for example, in accordance with the motion of the subject determined at step S13. In a case where the subject has no motion, the stroboscopic model in which the 3D models of the subject at the plurality of times with no motion are arranged, is likely to be a hard-to-view stroboscopic model in which the 3D models of the subject at the plurality of times are arranged at positions substantially the same. Thus, at step S14, in a case where the subject has no motion, it can be determined that the stroboscopic model is not to be generated, and in a case where the subject has motion, it can be determined that the stroboscopic model is to be generated.

Note that the determination of whether the stroboscopic model is to be generated at step S14 can be performed, as another example, in accordance with an operation of the user.

In a case where it is determined at step S14 that the stroboscopic model is not to be generated, the image processing unit 13 supplies the free viewpoint image generation unit 14 with the free viewpoint data from the free viewpoint data generation unit 12. Then, the processing skips steps S15 to S20 so as to proceed from step S14 to step S21.

In this case, at step S21, with the free viewpoint data from the image processing unit 13, the free viewpoint image generation unit 14 generates, as the free viewpoint image, the 2D image in which the 3D model as the free viewpoint data is viewed from the virtual viewpoint corresponding to an operation of the user. Then, the free viewpoint image generation unit 14 supplies the free viewpoint image to the display unit 15, and the processing proceeds from step S21 to step S22.

At step S22, the display unit 15 displays the free viewpoint image from the free viewpoint image generation unit 14. In this case, the display unit 15 displays the 2D image showing the 3D model of the subject viewed from the virtual viewpoint.

Meanwhile, in a case where it is determined at step S14 that the stroboscopic model is to be generated, the processing proceeds to step S15.

At step S15, the stroboscopic model generation unit 21 selects frames to be used for generation of the stroboscopic model (hereinafter, each is also referred to as a generation frame) from the frames for the 3D model supplied from the free viewpoint data generation unit 12, and the processing proceeds to step S16.

Here, for generation of the stroboscopic model, in accordance with, for example, an operation of the user, the forefront frame (time) and the last frame of the subject for arrangement of the 3D model in the stroboscopic model are set for a group of frames of viewpoint image showing the subject as the 3D model. The section from the forefront frame to the last frame showing the subject for arrangement of the 3D model in the stroboscopic model, is defined as a stroboscopic section. Use of all the frames in the stroboscopic section as the generation frame for generation of the stroboscopic model, is likely to cause the 3D models of the identical subject to be arranged in overlapping in the stroboscopic model, the 3D models being identical in number to the frames in the stroboscopic section. Thus, the 3D stroboscopic image is hard to view.

Thus, the stroboscopic model generation unit 21 selects frames as the generation frame from the frames in the stroboscopic section, and generates the stroboscopic model (free viewpoint data thereof) with each generation frame (3D model of the subject shown therein).

The stroboscopic model generation unit 21 can select, as the generation frame, the frames in which the degree of interference of the 3D model is a threshold value or less, from the frames in the stroboscopic section. In other words, with the 3D models of the subject shown in the frames in the stroboscopic section, arranged in the three-dimensional space, the stroboscopic model generation unit 21 calculates the degree of interference indicating the degree of overlapping between the 3D models. For example, the degree of interference is calculated as 100% in a case where the 3D models in arbitrary two frames completely overlap each other in the three-dimensional space, and the degree of interference is calculated as 0% in a case where the 3D models do not overlap each other at all. Then, the stroboscopic model generation unit 21 selects the frames in which the degree of interference is the predetermined threshold value or less, as the generation frame. As described above, the frames in which the degree of interference of the 3D model is the threshold value or less, as the generation frame, are selected from the frames in the stroboscopic section, and the stroboscopic model in which the 3D models of the subject shown in the generation frames are arranged, is generated. Thus, the 3D stroboscopic image can be inhibited from being a hard-to-view image due to the 3D models arranged in overlapping in the stroboscopic model.

Note that, for selection of the generation frame, as another example, simply, frames can be selected from the frames in the stroboscopic section at intervals of a predetermined number of frames.

At step S16, the stroboscopic model generation unit 21 generates, for example, the stroboscopic model in which the 3D models (of the subject shown) in the plurality of generation frames selected from the frames in the stroboscopic section are arranged in the background as the three-dimensional space at capturing of the subject of each 3D model. Then, the processing proceeds from step S16 to step S17.

Hereinafter, the stroboscopic model that the stroboscopic model generation unit 21 generates is also referred to as a default model.

Note that, in a case where only one subject is shown in each of the plurality of generation frames, the stroboscopic model generation unit 21 generates the stroboscopic model in which the 3D models of the one subject are arranged. Furthermore, in a case where a plurality of subjects is shown in each of the plurality of generation frames, the stroboscopic model generation unit 21 can generate the stroboscopic model in which the respective 3D models of the plurality of subjects are arranged. Note that, in the case where a plurality of subjects is shown in each of the plurality of generation frames, the stroboscopic model generation unit 21 can generate, for example, the stroboscopic model in which the 3D models of one subject or the respective 3D models of at least two subjects specified by the user from the plurality of subjects shown in the plurality of generation frames are arranged.

At step S17, in accordance with an operation of the user, the model selection unit 22 selects 3D models to be arranged finally in the stroboscopic model from the 3D models arranged in the default model, and generates the stroboscopic model in which the selected 3D models are arranged, namely, the stroboscopic model adjusted in the density of 3D models. Then, the processing proceeds to step S18. The following processing is performed to the stroboscopic model generated by the model selection unit 22.

At step S18, in accordance with an operation of the user, the effect processing unit 23 performs the effect processing to the 3D models in the stroboscopic model (3D models arranged in the stroboscopic model). For example, the effect processing unit 23 performs the effect processing to the 3D models in either the past or the future or in both of the past and the future with respect to the criterial 3D model specified in accordance with, for example, an operation of the user, from the 3D models at the plurality of times (generation frames) arranged in the stroboscopic model.

At step S19, in accordance with an operation of the user, the overlay image processing unit 25 overlays the overlay image on the stroboscopic model, and the processing proceeds to step S20.

At step S20, the camerawork setting unit 24 sets the camerawork of the virtual camera, in accordance with the state of the 3D models arranged in the stroboscopic model. Here, the camerawork that the camerawork setting unit 24 sets in accordance with the state of the 3D models arranged in the stroboscopic model, is also referred to as default camerawork.

After setting the default camerawork, in accordance with an operation of the user, the camerawork setting unit 24 changes the default camerawork.

The stroboscopic model after the overlay in the overlay image processing unit 25 and the camerawork acquired by the change of the default camerawork in the camerawork setting unit 24 are supplied from the image processing unit 13 to the free viewpoint image generation unit 14. Then, the processing proceeds from step S20 to step S21.

At step S21, the free viewpoint image generation unit 14 generates, by rendering, the free viewpoint image as the 3D stroboscopic image in which the stroboscopic model from the image processing unit 13 is captured by the virtual camera in accordance with the camerawork from the image processing unit 13. Then, the free viewpoint image generation unit 14 supplies the 3D stroboscopic image to the display unit 15, and the processing proceeds from step S21 to step S22.

At step S22, the display unit 15 displays the 3D stroboscopic image from the free viewpoint image generation unit 14. In this case, the display unit 15 displays, as the 3D stroboscopic image, the 2D image showing the 3D models of the subject shown in the plurality of generation frames viewed from the capturing position of the virtual camera to the stroboscopic model.

As described above, in accordance with the state of the 3D models arranged in the stroboscopic model, the camerawork setting unit 24 sets the default camerawork as the camerawork of the virtual camera, so that the video content of the 3D stroboscopic image can be easily produced.

Note that, herein, for easier understanding of description, the example in which the stroboscopic model is generated and then the effect processing is performed to the 3D models arranged in the stroboscopic model, has been given. However, generation of the stroboscopic model and the effect processing to the 3D models to be arranged in the stroboscopic model can be performed in parallel or in appropriate changeable order. For example, after the effect processing to the 3D models, the image processing unit 13 can generate the stroboscopic model in which the 3D models subjected to the effect processing are arranged.

<Generation of 3D Stroboscopic Image>

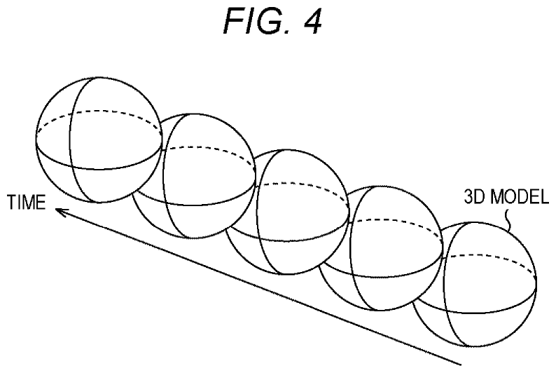

FIG. 4 is an illustration of an unnatural 3D stroboscopic image.

FIG. 4 illustrates the 3D stroboscopic image generated from the stroboscopic model generated with five frames, as the generation frame, from frames of viewpoint image in which a ball as the subject rolling from the near side to the far side is captured.

In FIG. 4, the 3D models of the ball shown in the five generation frames are arranged (rendered) with the temporally downstream 3D model having priority. Therefore, although being located on the far side, the temporally downstream 3D model (of the ball) conceals partially the temporally upstream 3D model on the near side thereof. As a result, the 3D stroboscopic image of FIG. 4 looks unnatural.

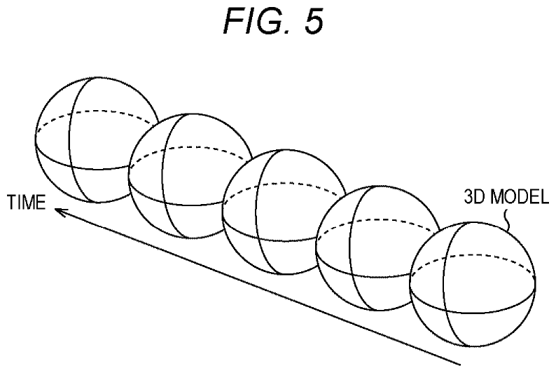

FIG. 5 is an illustration of an natural 3D stroboscopic image.

FIG. 5 illustrates the 3D stroboscopic image generated from the stroboscopic model generated with five frames, as the generation frame, from frames of viewpoint image in which a ball as the subject rolling from the near side to the far side is captured.

In FIG. 5, the 3D models of the ball shown in the five generation frames are arranged with the 3D model on the near side having priority. Therefore, the 3D model on the near side conceals partially the 3D model on the far side thereof, namely, the 3D model on the near side is shown preferentially. As a result, the free viewpoint image looks natural.

With the depth of each 3D model arranged in the stroboscopic model, the free viewpoint image generation unit 14 generates the 3D stroboscopic image showing preferentially the 3D model on the near side as described above (capturing by the virtual camera).

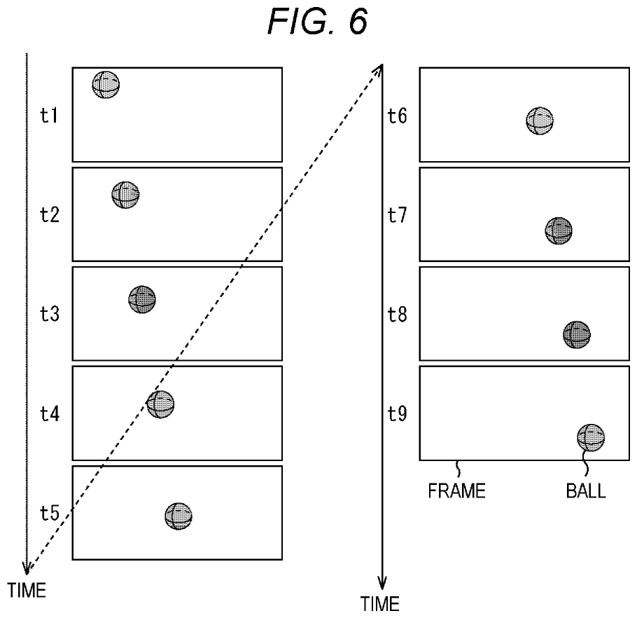

FIG. 6 is an illustration of frames of viewpoint image in the stroboscopic section.

In FIG. 6, the frames of viewpoint image in the stroboscopic section include nine frames at time t1 to time t9. The frames at time t1 to time t9 show a ball as the subject rolling from left to right.

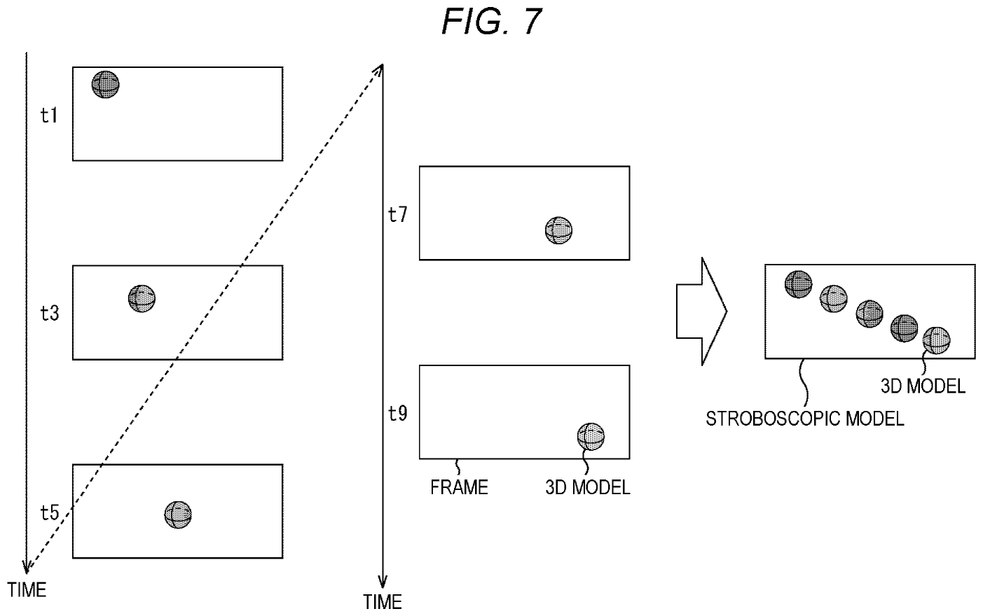

FIG. 7 is an illustration of generation of the stroboscopic model with frames between time t1 and time t9 as the stroboscopic section.

In FIG. 7, the frames at times t1, t3, t5, t7, and t9 between time t1 and time t9 as the stroboscopic section are selected as the generation frame, and the 3D model is generated for the ball as the subject shown in the frames at times t1, t3, t5, t7, and t9 as the generation frame for the viewpoint images at a plurality of viewpoints. Then, the stroboscopic model is generated in which the 3D models of the ball shown in the frames at times t1, t3, t5, t7, and t9 as the generation frame are arranged.

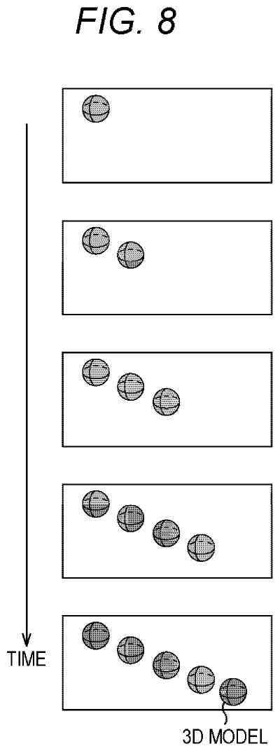

FIG. 8 is an illustration of display of the 3D stroboscopic image generated by capturing of the stroboscopic model by the virtual camera.

As video of the 3D stroboscopic image, from the stroboscopic image of FIG. 7, a frame showing the 3D model of the ball as the subject shown in the frame at time t1, a frame showing the 3D models of the ball as the subject shown in the frames at times t1 and t3, a frame showing the 3D models of the ball as the subject shown in the frames at times t1, t3, and t5, a frame showing the 3D models of the ball as the subject shown in the frames at times t1, t3, t5, and t7, and a frame showing the 3D models of the ball as the subject shown in the frames at times t1, t3, t5, t7, and t9 are generated so as to be displayed sequentially.

In the 3D stroboscopic image of FIG. 8, the capturing position of the virtual camera that captures the stroboscopic model remains unchanged, but the capturing position of the virtual camera can be changed in accordance with the camerawork. For example, the stroboscopic model in which the 3D models of the ball as the subject shown in the frames at times t1, t3, t5, t7, and t9 are arranged, can be captured by the virtual camera with the capturing position being changed. In a case where the capturing position is changed, the viewpoint from which the stroboscopic model is viewed is changed, so that the 3D stroboscopic image varying in camera angle is displayed.

<UI for Selection of 3D Models to be Arranged in Stroboscopic Model>

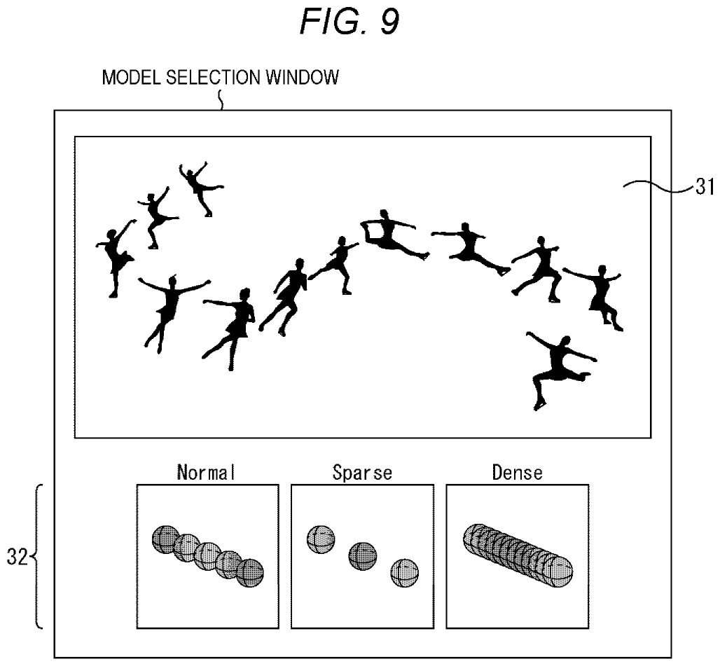

FIG. 9 is an illustration of a user interface (UI) for selection of 3D models to be arranged in the stroboscopic model.

FIG. 9 illustrates a model selection window as the UI for selection of 3D models to be arranged in the stroboscopic model.

Through the free viewpoint image generation unit 14, the model selection unit 22 causes the display unit 15 to display the model selection window.

The model selection window includes a display portion 31 and an operation portion 32.

On the display portion 31, (a stroboscopic image corresponding to) the stroboscopic model in which 3D models selected in response to an operation to the operation portion 32 are arranged, is displayed as the preview.

The operation portion 32 including, for example, a normal button (icon), a sparse button, and a dense button, is operated for selection of 3D models to be arranged in the stroboscopic model. The stroboscopic model in which 3D models selected in response to an operation to the normal button are arranged, is defined as a normal model, the stroboscopic model in which 3D models selected in response to an operation to the sparse button are arranged, is defined as a sparse model, and the stroboscopic model in which 3D models selected in response to an operation to the dense button are arranged, is defined as a dense model. With the distribution of 3D models in the normal model as the criterion in density, the sparse model is sparser in the distribution of 3D models than the normal mode, and the dense model is denser in the distribution of 3D models than the normal model.

In the model selection unit 22, the dense model is generated by selection of all or part of the 3D models arranged in the default model. The normal model is generated by selection of part of the 3D models arranged in the default model, the part being fewer in number than the 3D models in the dense model. The sparse model is generated by selection of part of the 3D models arranged in the default model, the part being fewer in number than the 3D models in the normal model.

For example, the normal model is displayed by default on the display portion 31.

The user operates the normal button, the sparse button, or the dense button in the operation portion 32 to select (the number of) 3D models to be arranged in the stroboscopic model, so that the user can adjust favorably the density of 3D models to be arranged in the stroboscopic model while verifying the stroboscopic model (the normal model, the sparse model, or the dense model) displayed on the display portion 31.

In the model selection unit 22, 3D models to be arranged in the stroboscopic model can be selected on the basis of, for example, the total number of 3D models, the degree of interference of 3D models, or the number of 3D models to be thinned out in temporal direction.

In a case where 3D models to be arranged in the stroboscopic model are selected on the basis of the total number of 3D models, for example, as 3D models to be arranged in the stroboscopic model from the 3D models arranged in the default model, equally spaced ten 3D models are selected for the normal model and equally spaced five 3D models are selected for the sparse model. For the dense model, for example, all of the 3D models arranged in the default model are selected as 3D models to be arranged in the stroboscopic model.

In a case where 3D models to be arranged in the stroboscopic model are selected on the basis of the degree of interference of 3D models, for example, from the 3D models arranged in the default model, 3D models to be arranged in the stroboscopic model are selected for the normal model such that the degree of interference of 3D models is 50%, and 3D models to be arranged in the stroboscopic model are selected for the sparse model such that the degree of interference of 3D models is 30%. For the dense model, for example, all of the 3D models arranged in the default model are selected as 3D models to be arranged in the stroboscopic model.

In a case where 3D models to be arranged in the stroboscopic model are selected on the basis of the number of 3D models to be thinned out in temporal direction, for example, as 3D models to be arranged in the stroboscopic model from the 3D models arranged in the default model, 3D models at intervals of two frames are selected for the normal model and 3D models at intervals of five frames are selected for the sparse model. For the dense model, for example, all of the 3D models arranged in the default model are selected as 3D models to be arranged in the stroboscopic model.

Note that, for selection of 3D models to be arranged in the stroboscopic model, as another example, the default model is displayed on the display portion 31, and 3D models specified by the user can be selected as 3D models to be arranged in the stroboscopic model from the 3D models arranged in the default model displayed on the display portion 31.

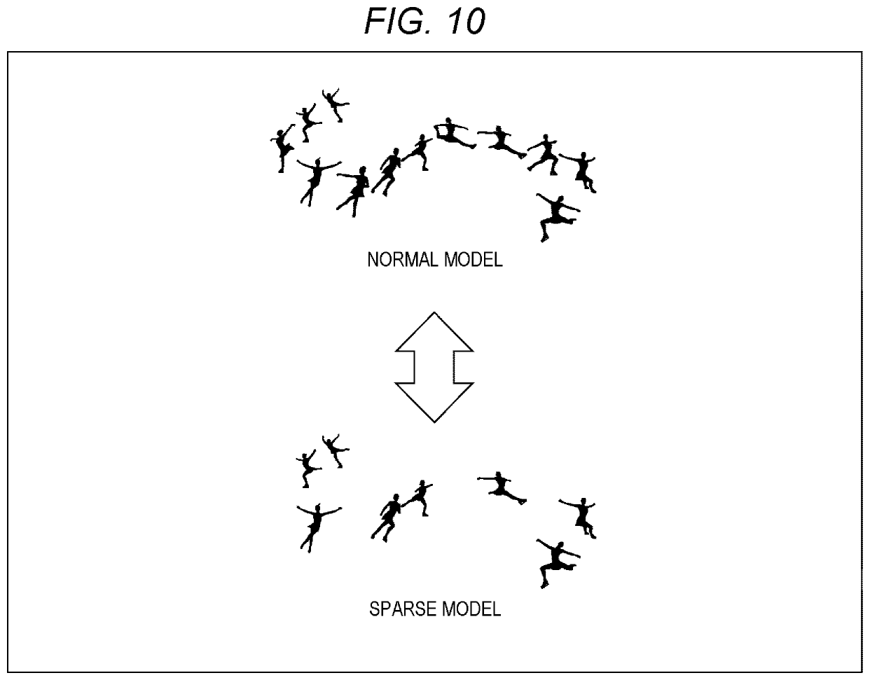

FIG. 10 is an illustration of a normal model and a sparse model.

The user operates the normal button or the sparse button in the operation portion 32, so that the stroboscopic model can be easily switched to the normal model or the sparse model as illustrated in FIG. 10.

<UI for Selection of Effect Processing to be Performed to 3D Models Arranged in Stroboscopic Model>

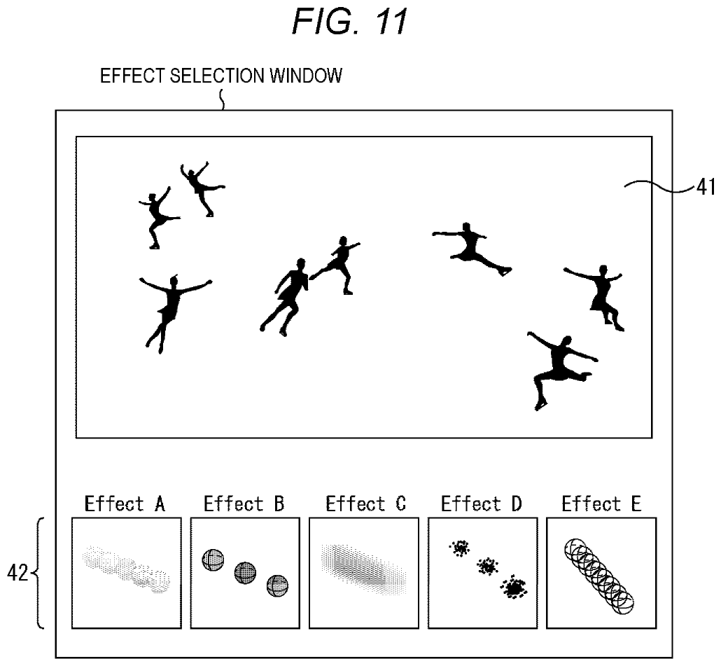

FIG. 11 is an illustration of a UI for selection of effect processing to be performed to the 3D models arranged in the stroboscopic model.

FIG. 11 illustrates an effect selection window as the UI for selection of effect processing to be performed to the 3D models arranged in the stroboscopic model.

Through the free viewpoint image generation unit 14, the effect processing unit 23 causes the display unit 15 to display the effect selection window.

The effect selection window includes a display portion 41 and an operation portion 42.

On the display portion 41, (a stroboscopic image corresponding to) the stroboscopic model in which the 3D models subjected to effect processing selected in response to an operation to the operation portion 42 are arranged, is displayed as the preview.

The operation portion 42 including, for example, buttons (icons) for pieces of effect processing A, B, C, D, and E, is operated for selection of effect processing to be performed to the 3D models arranged in the stroboscopic model.

The effect processing A is, for example, effect processing of changing the texture of 3D models, and the effect processing B is, for example, effect processing of changing the color of 3D models. The effect processing C is, for example, effect processing of blurring 3D models, and the effect processing D is, for example, effect processing of reducing the number of points of point-cloud 3D models such that the 3D models gradually disappear. The effect processing E is effect processing of transparentizing 3D models.

An operation to any of the buttons for pieces of effect processing A, B, C, D, and E causes the effect processing unit 23 to perform the effect processing corresponding to the operated button, to the 3D models arranged in the stroboscopic model, so that the stroboscopic model (in which the 3D models are arranged) after the effect processing, is displayed on the display portion 41.

Therefore, the user operates any of the buttons for pieces of effect processing A, B, C, D, and E in the operation portion 42 to select effect processing to be performed to the 3D models arranged in the stroboscopic model, so that the user can determine effect processing to be performed to the 3D models arranged in the stroboscopic model while verifying the stroboscopic model after the effect processing, displayed on the display portion 41.

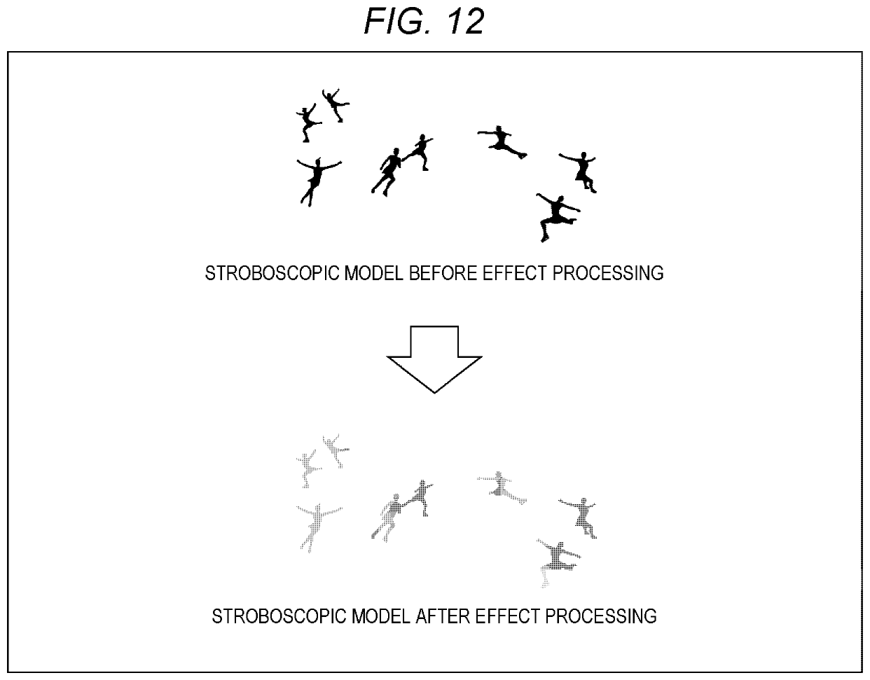

FIG. 12 is an illustration of a stroboscopic model before the effect processing and a stroboscopic model after the effect processing.

The user operates, for example, the button for effect processing B in the operation portion 42, so that the color of the 3D models arranged in the stroboscopic model can be changed as illustrated in FIG. 12.

Note that the selection of 3D models to be arranged in the stroboscopic model in the model selection unit 22 and the effect processing to the 3D model arranged in the stroboscopic model in the effect processing unit 23 are not particularly limited in the order of performance. In other words, for the selection of 3D models to be arranged in the stroboscopic model in the model selection unit 22 and the effect processing to the 3D model arranged in the stroboscopic model in the effect processing unit 23, the latter effect processing can be performed after the former 3D-model selection is performed, or the former 3D-model selection can be performed after the latter effect processing is performed. Furthermore, the former 3D-model selection and the latter effect processing can be performed simultaneously.

<3D Models to be Subjected to Effect Processing>

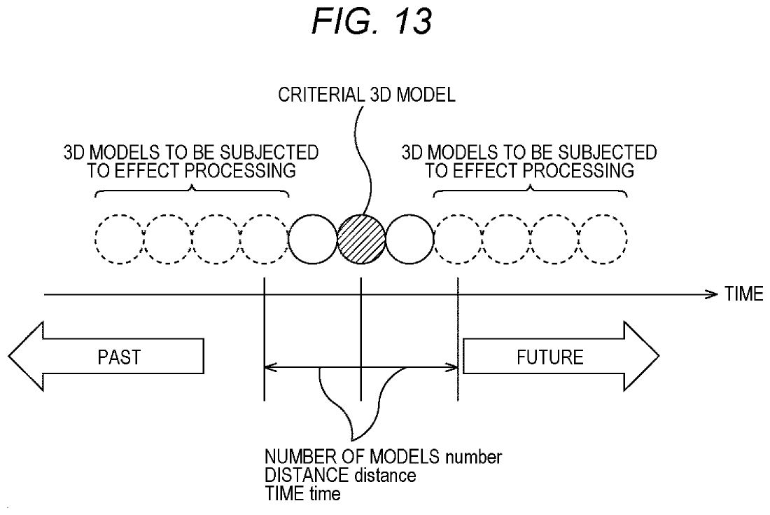

FIG. 13 is an illustration for describing 3D models to be subjected to the effect processing in the effect processing unit 23, in the stroboscopic model.

The effect processing unit 23 can perform the effect processing to the 3D models in either the past or the future or in both of the past and the future with respect to the criterial 3D model from the 3D models in the plurality of generation frames as the plurality of times selected from the frames in the stroboscopic section, in the stroboscopic model.

A target model including a 3D model to be subjected to the effect processing is specified with effect direction expressing the temporal direction to the criterial 3D model (past direction and future direction) and effect distance expressing the degree of separation from the criterial 3D model.

As the effect direction, the past direction “past” or the future direction “future”, or both of the past direction “past” and the future direction “future” can be set.

In a case where the past direction “past” is set as the effect direction, the effect processing is performed to the 3D models in the past direction from the criterial 3D model. In a case where the future direction “future” is set as the effect direction, the effect processing is performed to the 3D models in the future direction from the criterial 3D model. In a case where the past direction “past” and the future direction “future” are set as the effect direction, the effect processing is performed to the 3D models in the past direction and the 3D models in the future direction from the criterial 3D model.

The effect distance can be specified with the number of models “number”, the distance “distance”, or the time “time” in 3D model from the criterial 3D model.

According to the number of models “number”, the 3D models apart by the number of models “number” or more from the criterial 3D model in the 3D models arranged in the stroboscopic model, namely, the 3D models (of the subject) shown in the generation frames used for the generation of the stroboscopic model, can be specified as the target model.

According to the distance “distance”, the 3D models apart by the distance “distance” or more from the criterial 3D model in the 3D models arranged in the stroboscopic model, can be specified as the target model.

According to the time “time”, the 3D models apart by the time “time” or more from the criterial 3D model in the 3D models arranged in the stroboscopic model, can be specified as the target model.

The effect processing unit 23 performs the effect processing to, as the target model, the 3D models apart by the number of models “number” or more, the distance “distance” or more, or the time “time” or more in either the past direction or the future direction or in both of the past direction and the future direction, from the criterial 3D model in the stroboscopic model.

For simplification of description, unless otherwise specified, the effect processing is performed to the 3D models in the past direction from the criterial 3D model, below.

Here, in a case where the stroboscopic section is long and a large number of frames are selected as the generation frame, the stroboscopic model is generated with a large number of 3D models.

The stroboscopic model generated with a large number of 3D models, is likely to be a hard-to-view image.

For example, for the stroboscopic model generated with a large number of 3D models, the 3D models at times before a certain period of time or more with respect to the criterial 3D model in the 3D models of a predetermined subject arranged in the stroboscopic model, are likely to become obstacles (in view) to the temporally late (future) 3D models or the 3D models of another subject.

Furthermore, for the stroboscopic model generated with a large number of 3D models, in a case where the subject moves so as to draw similar trajectories, for example, in a case where the subject is doing so-called giant swings (backward swings or forward swings) around an iron rod, because the temporally early (past) 3D models and the temporally late 3D models draw similar trajectories, the elapse in time is likely to be hard to grasp.

Moreover, for the stroboscopic model generated with a large number of 3D models, because the data volume of 3D models is large, the throughput necessary for display of (the free viewpoint image generated from) the stroboscopic model is large.

Performance of the effect processing to the 3D models arranged in the stroboscopic model in the effect processing unit 23 enables provision of an easy-to-view stroboscopic model, and furthermore, reduction of the data volume of the stroboscopic model and reduction of the throughput necessary for display of the stroboscopic model.

<Specific Examples of Effect Processing>

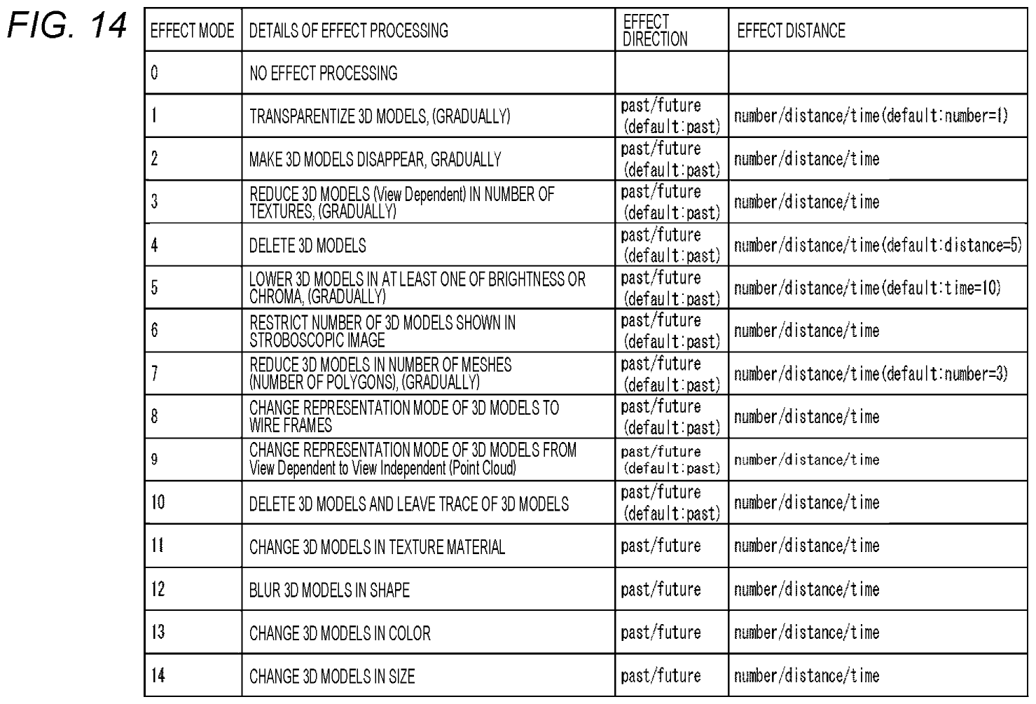

FIG. 14 is a table for describing specific examples of the effect processing.

In FIG. 14, the effect processing has effect modes 0, 1, 2, 3, 4, 5, 6, 7, 8, 9, 10, 11, 12, 13, and 14. For the effect modes 1 to 14, the effect direction and the effect distance described in FIG. 13 can be set.

Note that, in a case where nothing is set as the effect direction, for example, the effect processing is performed with the past direction “past” set by default as the effect direction.

The effect distance is specified with the number of models “number”, the distance “distance”, or the time “time” in 3D model from the criterial 3D model, as described in FIG. 13. For example, in a case where the past direction “past” is set as the effect direction and the number of models “number”=1 is set as the effect distance, the effect processing in the effect mode is performed to, as the target model, the 3D models apart by the number of models “number”=1 or more in the past direction from the criterial 3D model.

The effect mode 0 represents that no effect processing is performed.

The effect mode 1 represents effect processing of transparentizing 3D models. In the effect processing in the effect mode 1, the target models can be made transparent all identically in the degree of transparency, or can be gradually made transparent, namely, the more apart in time or in distance from the criterial 3D model a 3D model (target model) is located, the higher the degree of transparency can be made. For example, definition of a parameter attendant on the effect mode 1 and use of the parameter enable specification of how to transparentize 3D models. Note that, in a case where the degree of transparency is 100%, the target models are completely transparent. In this case, the result of the effect processing in the effect mode 1 is substantially similar to that in the effect mode 4 described later.

The effect mode 2 represents effect processing of making 3D models disappear gradually.

The effect mode 3 represents effect processing of reducing the numbers of textures of 3D models (the numbers of 2D images used as texture). In the effect processing in the effect mode 3, the numbers of textures of the target models can be reduced all identically in number, or can be gradually reduced, namely, the more apart in time or in distance from the criterial 3D model a 3D model is located, the more the number of textures can be reduced. For example, definition of a parameter attendant on the effect mode 3 and use of the parameter enable specification of how to reduce the numbers of textures of 3D models.

Note that the effect processing in the effect mode 3 is intended for 3D models to which the texture mapping is performed, namely, for the VD model, but is not intended for the VI model to which no texture mapping is performed.

The effect mode 4 represents effect processing of deleting 3D models.

The effect mode 5 represents effect processing of lowering 3D models in at least one of brightness or chroma. In the effect processing in the effect mode 5, the target models can be lowered in brightness and chroma all at identical rates, or can be gradually lowered, namely, the more apart in time or in distance from the criterial 3D model a 3D model is located, the larger the rate of lowering brightness and chroma can be made. For example, definition of a parameter attendant on the effect mode 5 and use of the parameter enable specification of how to lower 3D models in brightness and chroma or specification of whether to lower brightness or chroma.

The effect mode 6 represents effect processing of restricting the number of 3D models to be arranged in the stroboscopic model. In the effect processing in the effect mode 6, 3D models to be arranged in the stroboscopic model are restricted to the 3D models that are not the target models in the 3D models in the generation frames.

The effect mode 7 represents effect processing of making 3D models low polygons, namely, reducing the numbers of meshes (the numbers of polygons) of 3D models. In the effect processing in the effect mode 7, the numbers of meshes of the target models can be reduced all identically in number, or can be gradually reduced, namely, the more apart in time or in distance from the criterial 3D model a 3D model is located, the more the number of meshes can be reduced. For example, definition of a parameter attendant on the effect mode 7 and use of the parameter enable specification of how to reduce the numbers of meshes of 3D models.

Note that the effect processing in the effect mode 7 is intended for 3D models including polygons, but is not intended for 3D models including no polygons, namely, for example, for 3D models including wire frames.

The effect modes 8 and 9 each represent effect processing of changing the representation mode of 3D models.

In other words, the effect mode 8 represents effect processing of changing 3D models including polygons to 3D models including wire frames.

The effect mode 9 represents effect processing of changing the representation mode of 3D models from View Dependent to View Independent, namely, effect processing of changing the VD model to the VI model (e.g., a point cloud).

The effect mode 10 represents effect processing of deleting 3D models and leaving the trace of the 3D models.

The effect mode 11 represents effect processing of changing the texture of 3D models (texture material). For example, definition of a parameter attendant on the effect mode 11 and use of the parameter enable specification of what type of texture the texture of 3D models is to be changed to.

The effect mode 12 represents effect processing of blurring (the shapes of) 3D models. For example, definition of a parameter attendant on the effect mode 12 and use of the parameter enable specification of the degree of blurring of 3D models.

The effect mode 13 represents effect processing of changing the color of 3D models. For example, definition of a parameter attendant on the effect mode 13 and use of the parameter enable specification of what type of color the color of 3D models is to be changed to.

The effect mode 14 represents effect processing of changing the size of 3D models. For example, definition of a parameter attendant on the effect mode 14 and use of the parameter enable specification of the degree of changing of the size of 3D models.

For the effect modes 1 to 14, although the effect direction and the effect distance can be set, as necessary, the default effect direction and the default effect distance can be defined

For example, as the default effect direction in the effect modes 1 to 10, the past direction “past” can be defined.

Furthermore, for example, as the default effect distance in the effect mode 1, the number of models “number”=1 can be defined.

In this case, if nothing is set as the effect direction and the effect distance in the effect mode 1, the effect processing in the effect mode 1 is performed to, as the target model, the 3D models apart by one model or more in the past direction from the criterial 3D model, namely, the 3D models before the next 3D model in the past direction of the criterial 3D model.

Moreover, for example, as the default effect distance in the effect mode 4, the distance “distance”=5 [m] can be defined.

In this case, if nothing is set as the effect direction and the effect distance in the effect mode 4, the effect processing in the effect mode 4 is performed to, as the target model, the 3D models apart by 5 m or more in the past direction from the criterial 3D model.

Furthermore, for example, as the default effect distance in the effect mode 5, the time “time”=10 [sec] can be defined.

In this case, if nothing is set as the effect direction and the effect distance in the effect mode 5, the effect processing in the effect mode 5 is performed to, as the target model, the 3D models apart by 10 sec or more in the past direction form the criterial 3D model.

Moreover, for example, as the default effect distance in the effect mode 7, the number of models “number”=3 can be defined.

In this case, if nothing is set as the effect direction and the effect direction in the effect mode 7, the effect processing in the effect mode 7 is performed to, as the target model, the 3D models apart by three models or more in the past direction from the criterial 3D model, namely, the 3D models before the third 3D model in the past direction of the criterial 3D model.

Note that, for the effect processing to be performed by the effect processing unit 23, a plurality of effect modes can be set. For example, in a case where the effect modes 1 and 3 are set for the effect processing, effect processing of transparentizing 3D models and reducing the number of textures is performed.

<Configuration of Camerawork Setting Unit 24>

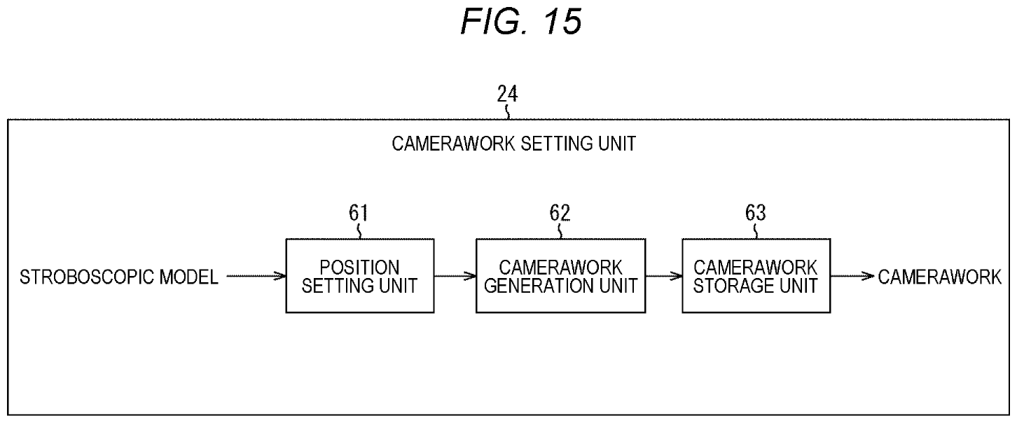

FIG. 15 is a block diagram of a configuration of the camerawork setting unit 24 of FIG. 2.

In FIG. 15, the camerawork setting unit 24 includes a position setting unit 61, a camerawork generation unit 62, and a camerawork storage unit 63.

The position setting unit 61 sets the capturing start position at which the virtual camera starts to capture the stroboscopic model and the capturing finish position at which the virtual camera finishes the capturing. For example, the position setting unit 61 sets the capturing start position and the capturing finish position, in accordance with the state of the 3D models in the distribution of the 3D models arranged in the stroboscopic model (hereinafter, also referred to as model distribution). For example, the position setting unit 61 can set, as the capturing start position, a position at which the stroboscopic model is captured such that the temporally earliest 3D model in the 3D models arranged in the stroboscopic model is conspicuous (e.g., displayed on the nearest side). Moreover, for example, the position setting unit 61 can set, as the capturing finish position, a position at which the stroboscopic model is captured such that the temporally latest 3D model in the 3D models arranged in the stroboscopic model is conspicuous.

As the model distribution of (the 3D models arranged in) the stroboscopic model, for example, the trajectory of the positions of the 3D models to be arranged in the stroboscopic model, recognizable at generation of the stroboscopic model, can be adopted. The trajectory of the positions of the 3D models to be arranged in the stroboscopic model can be retained as metadata of the stroboscopic model.

Furthermore, the model distribution of the stroboscopic model can be recognized by an analysis of the stroboscopic model in the position setting unit 61.

Together with the capturing start position and the capturing finish position, the position setting unit 61 supplies the stroboscopic model to which the capturing start position and the capturing finish position are set, to the camerawork generation unit 62.

In accordance with the state of the 3D models arranged in the stroboscopic model, the camerawork generation unit 62 generates (and sets) the default camerawork for capturing of the stroboscopic model from the position setting unit 61 by the virtual camera moving from the capturing start position to the capturing finish position from the position setting unit 61 and moreover as necessary from the capturing finish position to the capturing start position.

In addition, in accordance with an operation of the user, the camerawork generation unit 62 can generate new camerawork or change the default camerawork.

The camerawork generated by the camerawork generation unit 62 is supplied to the camerawork storage unit 63.

The camerawork storage unit 63 temporarily stores the camerawork from the camerawork generation unit 62, and supplies the camerawork to the free viewpoint image generation unit 14 (FIG. 1).

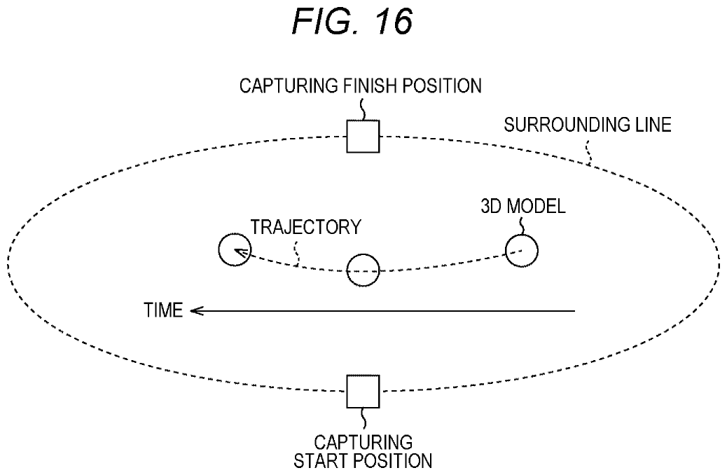

FIG. 16 an illustration of a first example in which the position setting unit 61 sets the capturing start position and the capturing finish position in accordance with the model distribution.

FIG. 16 schematically illustrates the 3D models arranged in the stroboscopic model, viewed from the upper side (plus side of the y axis in the xyz coordinate system).

For the stroboscopic model, the position setting unit 61 obtains a surrounding line that surrounds the 3D models arranged in the stroboscopic model, in accordance with the model distribution. For example, an elliptically circumferential line that surrounds the periphery in the horizontal direction (direction in which the xy plane in the xyz coordinate system extends) of the model distribution of the 3D models arranged in the stroboscopic model, is obtained as the surrounding line.

Then, in the first example for setting of the capturing start position and the capturing finish position, in accordance with the trajectory of the 3D models arranged in the stroboscopic model, the position setting unit 61 sets, as the capturing start position, a position on the surrounding line in the perpendicular direction of the trajectory (model trajectory) of the 3D models arranged in the stroboscopic model from the vicinity of the midpoint of the model trajectory, and sets, as the capturing finish position, the position on the surrounding line opposed to the capturing start position across the model distribution of the stroboscopic model.

As described above, setting of the capturing start position and the capturing finish position enables capturing of the stroboscopic model to start and finish such that each 3D model arranged in the stroboscopic model is shown in the 3D stroboscopic image in as uniform in density as possible.

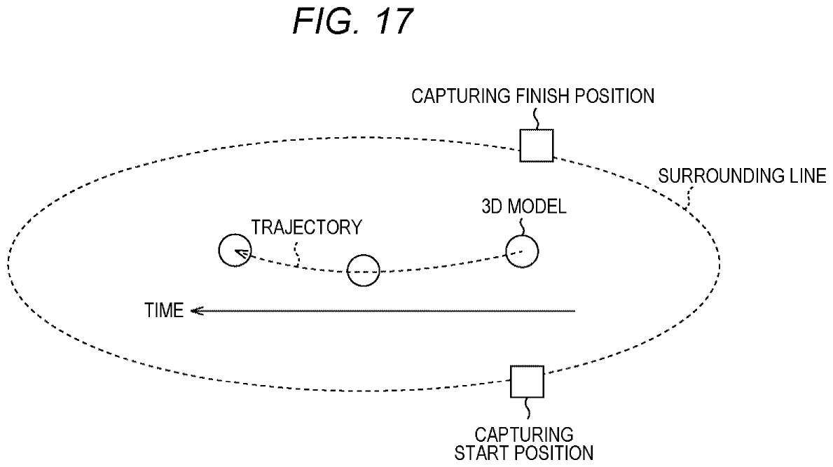

FIG. 17 is an illustration of a second example in which the position setting unit 61 sets the capturing start position and the capturing finish position in accordance with the model distribution.

FIG. 17 schematically illustrates the 3D models arranged in the stroboscopic model, viewed from the upper side, similarly to FIG. 16.

In the second example for setting of the capturing start position and the capturing finish position, for the stroboscopic model, the position setting unit 61 obtains a surrounding line that surrounds the 3D models arranged in the stroboscopic model, in accordance with the model distribution, similarly to the first example for setting of the capturing start position and the capturing finish position.

Then, in the second example for setting of the capturing start position and the capturing finish position, in accordance with the trajectory of the 3D models arranged in the stroboscopic model, the position setting unit 61 sets, as the capturing start position, a position on the surrounding line in the perpendicular direction of the model trajectory from the temporally earliest 3D model, and sets, as the capturing finish position, the position on the surrounding line opposed to the capturing start position across the temporally earliest 3D model.

As described above, setting of the capturing start position and the capturing finish position enables capturing of the stroboscopic model to start and finish such that the plurality of 3D models arranged in the stroboscopic model is shown in the 3D stroboscopic image in as uniform in density as possible from a position near the temporally earliest 3D model.

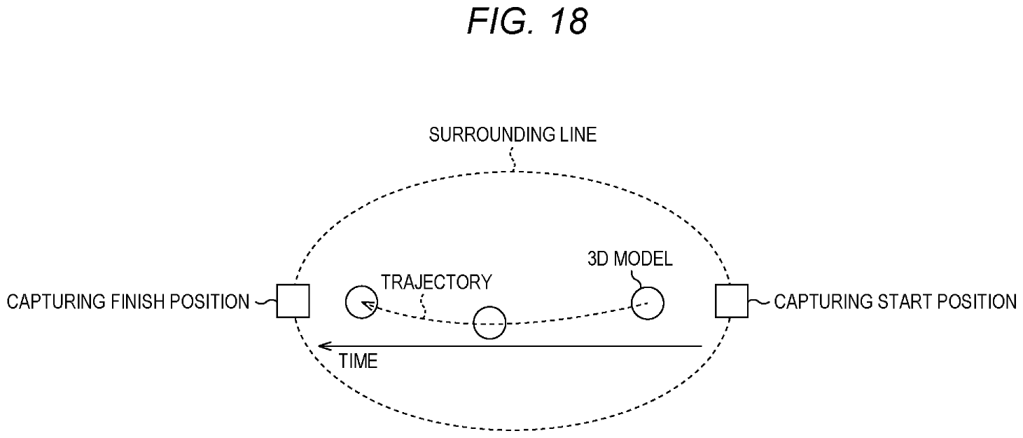

FIG. 18 is an illustration of a third example in which the position setting unit 61 sets the capturing start position and the capturing finish position in accordance with the model distribution.

FIG. 18 schematically illustrates the 3D models arranged in the stroboscopic model, viewed from the upper side, similarly to FIG. 16.

In the third example for setting of the capturing start position and the capturing finish position, for the stroboscopic model, the position setting unit 61 obtains a surrounding line that surrounds the 3D models arranged in the stroboscopic model, in accordance with the model distribution, similarly to the first example for setting of the capturing start position and the capturing finish position.

Then, in the third example for setting of the capturing start position and the capturing finish position, in accordance with the trajectory of the 3D models arranged in the stroboscopic model, the position setting unit 61 sets, as the capturing start position, a position on the surrounding line close (closest) to the start point of the model trajectory, and sets, as the capturing finish position, a position on the surrounding line close (closest) to the end point of the model trajectory.

As described above, setting of the capturing start position and the capturing finish position enables capturing of the stroboscopic model to start at a camera angle at which the temporally earliest 3D model in the plurality of 3D models arranged in the stroboscopic model is conspicuously shown in the 3D stroboscopic image and to finish at a camera angle at which the temporally latest 3D model is conspicuously shown in the 3D stroboscopic image.

<Generation of Default Camerawork>

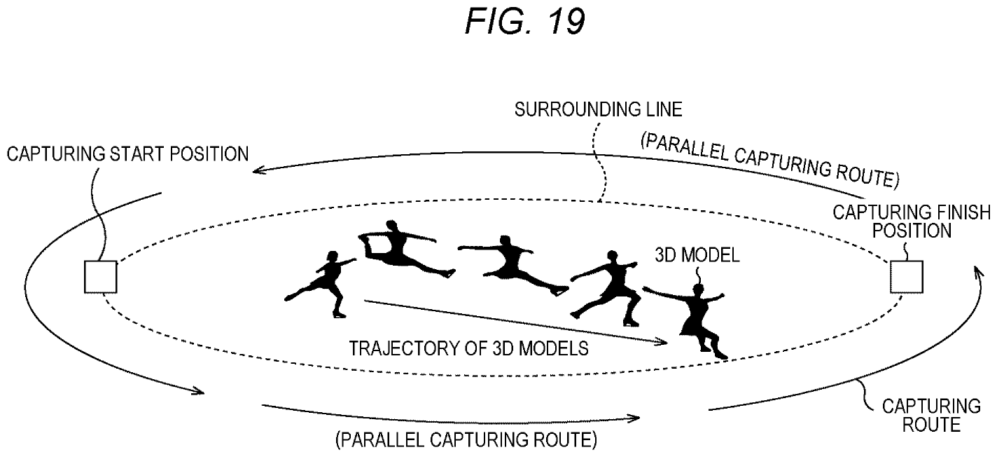

FIG. 19 is an illustration of generation of the default camerawork by the camerawork generation unit 62.

The camerawork generation unit 62 sets one of a counterclockwise route or a clockwise route on the surrounding line from the capturing start position to the capturing finish position, for example, the counterclockwise route as the capturing route on which the virtual camera moves. Moreover, as necessary, the camerawork generation unit 62 sets a return route on the surrounding line from the capturing finish position to the capturing start position as the capturing route.

Then, the camerawork generation unit 62 sets, on the capturing route, the capturing position at which the virtual camera captures the stroboscopic model in which the 3D models are arranged. For example, an image acquired by capturing of the stroboscopic model by the virtual camera at the capturing position results in one frame of 3D stroboscopic image. Therefore, setting the capturing position densely causes the 3D stroboscopic image to be an image as if being subjected to slow reproduction, and setting the capturing position sparsely causes the 3D stroboscopic image to be an image as if being subjected to fast-forward reproduction.

The capturing position can be set relatively densely to the capturing route relatively along the trajectory of the 3D models of the stroboscopic model (hereinafter, also referred to as a parallel capturing route). The capturing position can be set sparser to another capturing route, namely, the capturing route relatively perpendicular to the trajectory of the 3D models than to the parallel capturing route. In this case, the 3D stroboscopic image including a scene in which the entirety of the plurality of 3D models arranged in the stroboscopic model is relatively viewable, is subjected to slow reproduction or normal reproduction (onefold-speed reproduction), and the 3D stroboscopic image including a scene in which the plurality of 3D models arranged in the stroboscopic model is hard to view because of overlapping, is subjected to fast-forward reproduction.

For each capturing position, the camerawork generation unit 62 sets as necessary the capturing attitude of the virtual camera and camera parameters, such as magnification in zooming. Then, data including the capturing position, the capturing attitude, and the camera parameters is generated as the default camerawork.

Note that, in a case where the camerawork generation unit 62 sets, as the capturing route, the route on the surrounding line from the capturing start position to the capturing finish position, and moreover sets, as the capturing route, the return route on the surrounding line from the capturing finish position to the capturing start position, loop reproduction (repetitive reproduction) can be performed to the stroboscopic image.

<Change of Camerawork>

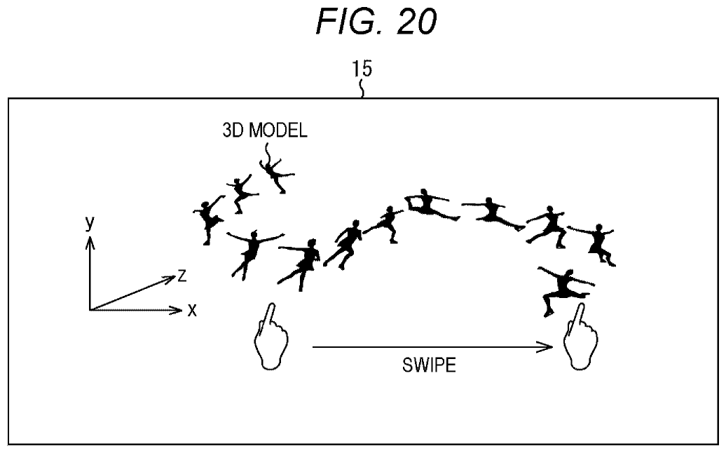

FIG. 20 is an illustration for describing change of the camerawork corresponding to an operation of the user.

In accordance with an operation of the user, the camerawork generation unit 62 can change (edit) the past generated camerawork including the default camerawork. Note that the camerawork generation unit 62 can generate new camerawork in accordance with an operation of the user, similarly to the change of the camerawork. Herein, a case where the default camerawork is changed will be described.

Through the free viewpoint image generation unit 14, the camerawork generation unit 62 causes the display unit 15 to display (the 3D stroboscopic image corresponding to) the stroboscopic model. The user performs a touch operation or an operation of a mouse pointer to the stroboscopic model displayed on the display unit 15, resulting in change of the default camerawork generated (set) for the stroboscopic model displayed on the display unit 15.

For example, with a swipe operation, the user can move the capturing position as the camerawork, parallel. Furthermore, for example, with a pinch operation, the user can change the magnification in zooming of the virtual camera (can cause the virtual camera to zoom in or zoom out). Moreover, for example, the user rotates two fingers in touch with the display unit 15 as the touch panel, resulting in rotation of the capturing attitude of the virtual camera around the x axis, the y axis, or the z axis.

Note that in a case where the user changes the default camerawork, for easier grasping of direction in the three-dimensional space in which the 3D models are arranged and for assistance for the operation of changing, the coordinate axes of the xyz coordinate system can be displayed on the display unit 15.

Here, the capturing position of the virtual camera is movable in the x axis, the y axis, and the z axis, and the capturing attitude of the virtual camera is rotatable around the x axis, the y axis, and the z axis. Therefore, six degrees of freedom (6DoF) are provided as the degree of freedom for the capturing position and the capturing attitude of the virtual camera.

For the capturing position and the capturing attitude of the virtual camera provided with 6DoF as the degree of freedom, detailed changing can be made. On the other hand, a user unfamiliar with the operation is likely to have difficulty in the operation of changing because of too many degrees of freedom.

Thus, with restriction of movement of the virtual camera for the x axis, the y axis, or the z axis, the camerawork generation unit 62 can change the capturing position and the capturing attitude of the virtual camera as the camerawork, in accordance with an operation of the user.

For example, in a case where rotation around the x axis is restricted, changing the capturing attitude of the virtual camera so as to have, for example, a camera angle for looking upward or a camera angle for looking downward, is restricted. For example, in a case where movement in the y axis is restricted, changing the capturing position of the virtual camera so as to move in the up-and-down direction, is restricted.

As described above, restriction of movement of the virtual camera for the x axis, the y axis, or the z axis enables improvement of the operability when a user unfamiliar with the operation changes the default camerawork.

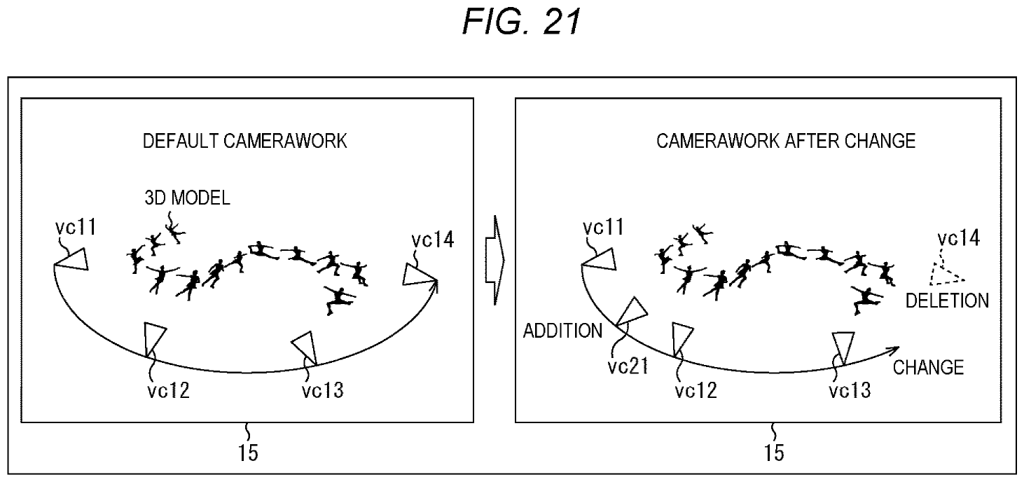

FIG. 21 is an illustration of change of the camerawork corresponding to an operation of the user.

The camerawork generation unit 62 causes the display unit 15 to display, for example, the 3D stroboscopic image in which the stroboscopic model is viewed from a predetermined viewpoint (e.g., a viewpoint at which all the 3D models arranged in the stroboscopic model are as visible as possible). Moreover, the camerawork generation unit 62 can cause the display unit 15 to display a guide icon vc #i simulant of the virtual camera so that the user changes the camerawork (default camerawork) easily.

The guide icon vc #i represents the capturing position and the capturing attitude (capturing direction) of the virtual camera. In a case where there is a possibility that display of the guide icon vc #i at all capturing positions causes degradation in the degree of vision because of too many guide icons vc #i, the guide icon vc #i can be displayed only at representative capturing positions in the capturing positions as the default camerawork.

The user performs an operation for changing, adding, or deleting the guide icon vc #i, resulting in change of the camerawork.

An increase in capturing position with addition of the guide icon vc #i causes the 3D stroboscopic image to be an image as if being subjected to slow reproduction. Meanwhile, a decrease in capturing position with deletion of the guide icon vc #i causes the 3D stroboscopic image to be an image as if being subjected to fast-forward reproduction.

After the user changes, adds, or deletes the guide icon vc #i, the camerawork generation unit 62 re-generates the camerawork in which interpolation is made in capturing position such that smooth connection is made between the guide icons vc #i (interpolation).

Note that the user can specify the moving speed of the virtual camera that moves between the guide icons vc #i. In accordance with the moving speed specified by the user, the camerawork generation unit 62 can interpolate a larger number of capturing positions between the guide icons vc #i for the moving speed that is slower, and can interpolate a smaller number of capturing positions between the guide icons vc #i for the moving speed that is faster.

In FIG. 21, guide icons vc11, vc12, vc13, and vc14 representing the representative capturing positions as the default camerawork are displayed. In a case where the user performs, for example, an operation for deleting the guide icon vc14, changing the guide icon vc13, and adding a guide icon vc21, the camerawork is changed as below.

In other words, in accordance with the operation of the user, the camerawork generation unit 62 deletes the capturing position corresponding to the guide icon vc14, and changes the capturing position and the capturing attitude corresponding to the guide icon vc13 in accordance with the change of the guide icon vc13, in the default camerawork. Moreover, the camerawork generation unit 62 adds, as the camerawork, the capturing position corresponding to the guide icon vc21.

As described above, the camerawork can be changed to user's favorite camerawork, in accordance with an operation of the user.

<Generation of Camerawork for Subject that is Animal, Such as Human>

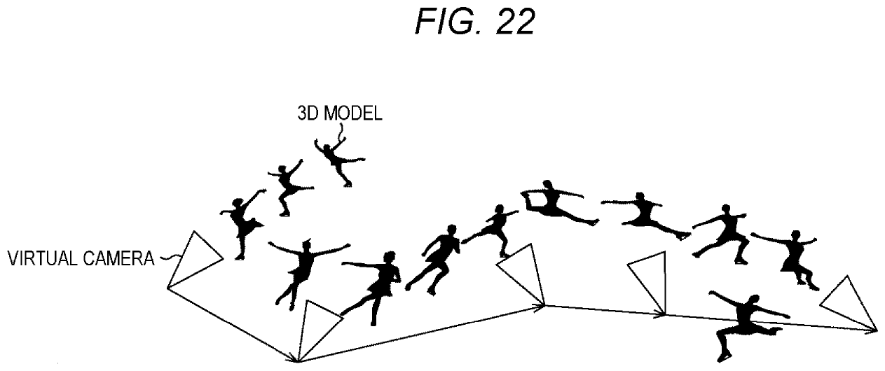

FIG. 22 is an illustration for describing generation of the camerawork in a case where the subject shown in the viewpoint image is an animal, such as a human.

In a case where the subject shown in the viewpoint image is an animal, such as a human, in accordance with the face of the subject, the camerawork generation unit 62 can generate the default camerawork for the stroboscopic model in which the 3D models of the subject are arranged. For example, the camerawork generation unit 62 obtains the capturing position and the capturing attitude of the virtual camera with which the stroboscopic model can be captured in the direction facing the face of the subject at each time (generation frame), so that the camerawork including the capturing position and the capturing attitude can be generated as the default camerawork.

In this case, the camerawork generation unit 62 detects the face with, for example, extraction of feature points of the face from the 3D models arranged in the stroboscopic model. Detection of the face can be performed to all the 3D models arranged in the stroboscopic model, or can be performed to part of the 3D models, such as alternate 3D models.

The camerawork generation unit 62 obtains the direction facing the face for the 3D models from which the face is detected. Then, the camerawork generation unit 62 obtains, as the capturing position, a predetermined position in the direction facing the face, obtains, as the capturing attitude, the attitude of the virtual camera at the capturing position with which the face can be captured from the front, and generates, as the default camerawork, the camerawork including the capturing position and the capturing attitude.

Note that, after performance of texture mapping to the 3D models arranged in the stroboscopic model, the camerawork generation unit 62 detects the face of the subject of each 3D model.

As described above, generation of the default camerawork enables reproduction of the 3D stroboscopic image in which the face of the subject of each 3D model is shown from the front.

<Selection of 3D Models to be Arranged in Stroboscopic Model Corresponding to State of 3D Models Arranged in Stroboscopic Model to be Captured by Virtual Camera>

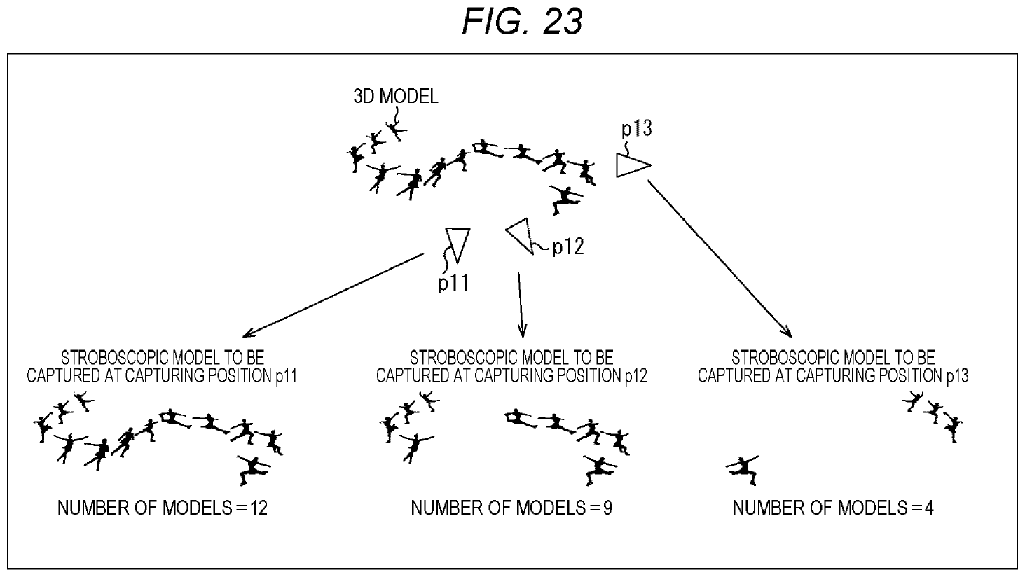

FIG. 23 is an illustration for describing selection of 3D models to be arranged in the stroboscopic model corresponding to the state of the 3D models arranged in the stroboscopic model to be captured by the virtual camera.

In addition to selection corresponding to an operation of the user as described in FIG. 9, 3D models to be arranged in the stroboscopic model can be selected (varied in number) in accordance with the state of the 3D models arranged in the stroboscopic model viewed from the virtual camera.

For example, 3D models to be arranged in the stroboscopic model can be selected in accordance with the degree of overlapping of the 3D models in a case where the virtual camera captures the stroboscopic model from the capturing position p #j in accordance with the camerawork.

Specifically, in a case where a 3D model on the far side overlaps a 3D model on the near side when viewed from the virtual camera in capturing of the stroboscopic model from the capturing position p #j, the 3D models except the 3D model on the far side overlapping the 3D model on the near side, can be selected as 3D models to be arranged in the stroboscopic model.

In this case, a hard-to-view stroboscopic image including the 3D model on the far side overlapping the 3D model on the near side, can be inhibited from being generated.

For example, 3D models selected as 3D models to be arranged in the stroboscopic model in capturing of the stroboscopic model from each capturing position p #j, can be retained in association with the capturing position p #j as the camerawork.

In this case, with the stroboscopic model in which the 3D models associated with the capturing position p #j are arranged, the free viewpoint image generation unit 14 renders the image including the stroboscopic model viewed from the capturing position p #j included in the camerawork.

In FIG. 23, twelve 3D models arranged in the stroboscopic model are selected all for capturing of the stroboscopic model from the capturing position p11. Nine 3D models are selected from the twelve 3D models arranged in the stroboscopic model for capturing of the stroboscopic model from the capturing position p12. Four 3D models are selected from the twelve 3D models arranged in the stroboscopic model for capturing of the stroboscopic model from the capturing position p13.

Therefore, in a case where the virtual camera captures the stroboscopic model while moving in the order of the capturing positions p11, p12, and p13, the number of 3D models to be arranged in the stroboscopic model reduces to twelve, nine, and four in this order.

Here, there is a possibility that sudden reduction of the number of 3D models from twelve to nine and from nine to four causes acquisition of the 3D stroboscopic image providing a sense of discomfort. Thus, in a case where 3D models to be arranged in the stroboscopic model are reduced, the effect processing unit 23 can perform effect processing such that 3D models to be subtracted fade out.

Conversely, in a case where the virtual camera captures the stroboscopic model while moving in the order of the capturing positions p13, p12, and p11, the number of 3D models to be arranged in the stroboscopic model increases to four, nine, and twelve in this order.

Here, there is a possibility that sudden increase of the number of 3D models from four to nine and from nine to twelve causes acquisition of the 3D stroboscopic image providing a sense of discomfort. Thus, in a case where 3D models to be arranged in the stroboscopic model are increased, the effect processing unit 23 can perform effect processing such that 3D models to be added fade in.

In a case where 3D models to be arranged in the stroboscopic model are reduced or increased, effect processing of varying the number of models gradually, such as integration or division of 3D models, can be performed, in addition to fading-out or fading-in of the 3D models.

<Setting of Capturing Start Position and Capturing Finish Position for Connection of Actual Image Before and after 3D Stroboscopic Image>

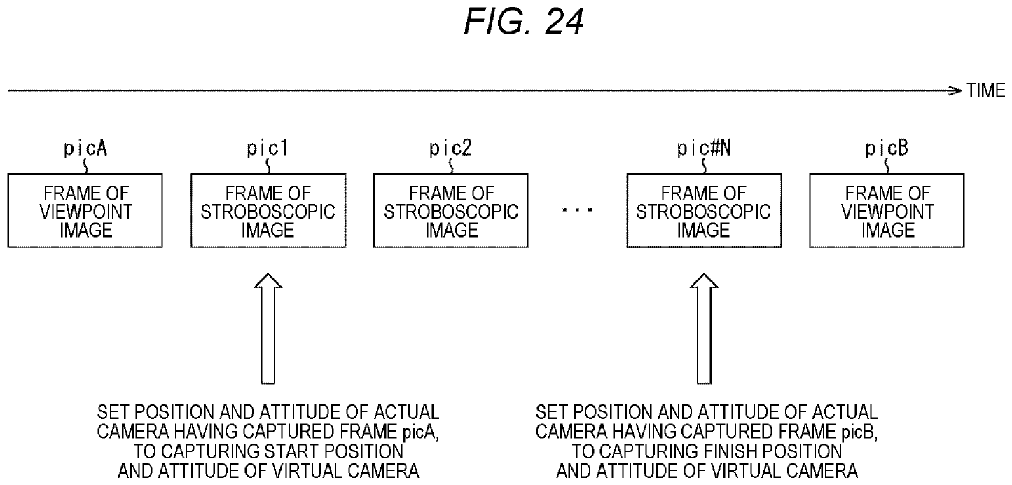

FIG. 24 is an illustration for describing setting of the capturing start position and the capturing finish position for connection of an actual image before and after the 3D stroboscopic image.

Here, the actual image means an image captured by an actual camera, and includes herein, for example, the viewpoint image captured by a camera in the image capturing unit 11.

In the generation frames to be used for generation of the stroboscopic model, the temporally earliest frame of the viewpoint image at a viewpoint vp #A is defined as a frame picA, and the temporally latest frame of the viewpoint image at a viewpoint vp #B is defined as a frame picB. Note that the viewpoint vp #A and the viewpoint vp #B may be identical or may be different.

For production of video including reproduction of the frame picA of the viewpoint image at the viewpoint vp #A, reproduction of the video including frames pic1 to pic #N as the 3D stroboscopic image acquired by capturing of the stroboscopic model generated with the generation frames, by the virtual camera, and reproduction of the frame picB of the viewpoint image at the viewpoint vp #B, in this order, the camerawork setting unit 24 sets the position (viewpoint vp #A) and the attitude of the actual camera having captured the frame picA to the capturing start position of the virtual camera and the capturing attitude at the capturing start position, and sets the position (viewpoint vp #B) and the attitude of the actual camera having captured the frame picB to the capturing finish position of the virtual camera and the capturing attitude at the capturing finish position, so that the default camerawork can be generated.

In this case, an identical scene captured at an identical camera angle is shown in each of the frame picA and the forefront frame pic1 of the 3D stroboscopic image. Moreover, an identical scene captured at an identical camera angle is shown in each of the last frame pic #N of the 3D stroboscopic image and the frame picB.

Therefore, the video including the viewpoint images as the actual image and the 3D stroboscopic image in smooth connection, can be easily produced. Such video is useful for instant replay for sports or replay of goal scenes in soccer, for example.

<Overlaying of Overlay Image>

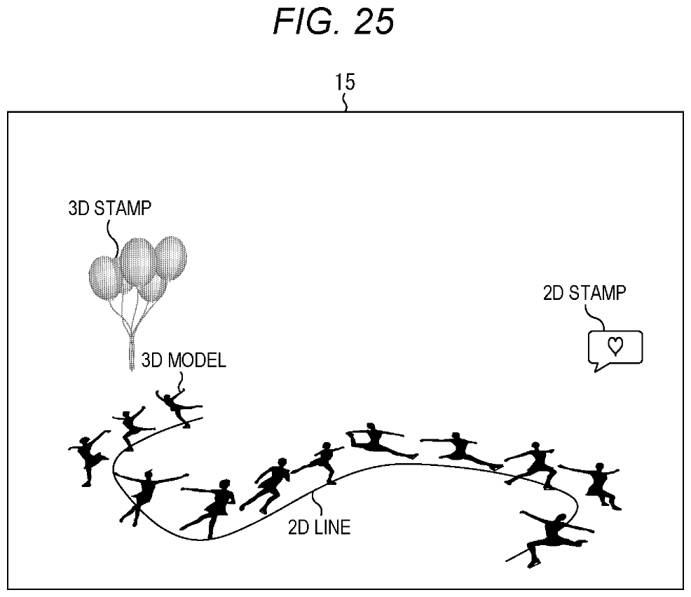

FIG. 25 is an illustration of overlaying of overlay images onto the stroboscopic model.

The overlay image processing unit 25 causes the display unit 15 to display (the 3D stroboscopic image corresponding to) the stroboscopic model.

Then, in accordance with an operation of the user, the overlay image processing unit 25 overlays, as an overlay image to be overlaid on the stroboscopic model, for example, a line, text, a figure, or a stamp including a 2D image or a 3D image, on the stroboscopic model.

Note that the overlay image, such as a line (2D line) or a stamp (2D stamp) including a 2D image, is shown in the 3D stroboscopic image as if being arranged in front of the virtual camera regardless of, for example, the capturing position of the virtual camera.

Meanwhile, similarly to the stroboscopic model, the overlay image, such as a stamp (3D stamp) including a 3D image, varies in the degree of vision in accordance with, for example, the capturing position of the virtual camera (state shown in the 3D stroboscopic image varies).

In FIG. 25, an image of balloons (3D model) is indicated as the overlay image including a 3D image. As the overlay image including a 3D image, for example, a colored point cloud can be adopted.

<Description of Computer to which an Aspect of the Present Technology has been Applied>

Next, the pieces of processing in series described above can be performed by hardware or by software. In a case where the pieces of processing in series are performed by software, a program included in the software is installed on, for example, a general-purpose computer.

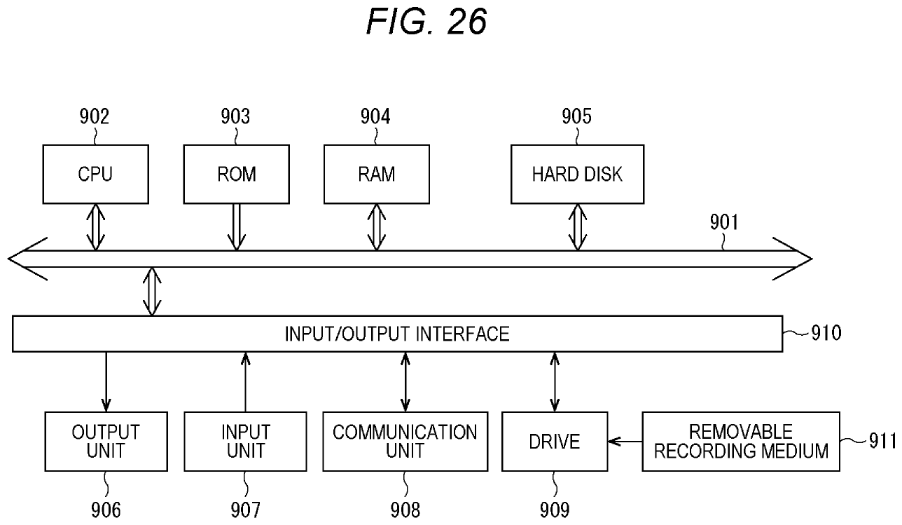

FIG. 26 is a block diagram of a configuration according to one embodiment of a computer on which the program for performance of the pieces of processing in series described above is installed.

The program can be previously recorded on a hard disk 905 or a ROM 903 as a recording medium built in the computer.

Alternatively, the program can be stored (recorded) in a removable recording medium 911 to be driven by a drive 909. Such a removable recording medium 911 can be provided as so-called packaged software. Here, examples of the removable recording medium 911 include a flexible disk, a compact disc read only memory (CD-ROM), a magneto optical (MO) disc, a digital versatile disc (DVD), a magnetic disk, and a semiconductor memory.

Note that the program not only can be installed from the removable recording medium 911 described above to the computer, but also can be installed on the built-in hard disk 905 by download to the computer through a communication network or a broadcast network. In other words, for example, the program can be transferred from a download site to the computer by wireless through an artificial satellite for digital satellite broadcasting, or can be transferred to the computer by wire through a network, such as a local area network (LAN) or the Internet.

The computer includes a central processing unit (CPU) 902 built therein, and the CPU 902 is connected with an input/output interface 910 through a bus 901.

When a command is input through the input/output interface 910 by, for example, an operation of the user to an input unit 907, the CPU 902 executes the program stored in the read only memory (ROM) 903, in accordance with the command. Alternatively, the CPU 902 loads the program stored in the hard disk 905, to a random access memory (RAM) 904 and executes the program.

This arrangement causes the CPU 902 to perform the processing along the flowchart described above or the processing to be performed in the configurations in the block diagrams described above. Then, as necessary, for example, the CPU 902 causes, through the input/output interface 910, an output unit 906 to output a result of the processing or a communication unit 908 to transmit the result of the processing, or moreover records the result of the processing on the hard disk 905.

Note that the input unit 907 includes a keyboard, a mouse, and a microphone. Furthermore, the output unit 906 includes a liquid crystal display (LCD) and a speaker.

Here, in the present specification, the processing that the computer executes in accordance with the program, is not necessarily performed on a time series basis in the order described as the flowchart. In other words, the processing that the computer executes in accordance with the program includes processing to be performed parallel or individually (e.g., parallel processing or processing with object).

Furthermore, the program may be subjected to processing by one computer (processor) or may be subjected to distributed processing by a plurality of computers. Moreover, the program may be transferred to a remote computer so as to be executed.

Moreover, in the present specification, the system means an aggregate of a plurality of constituent elements (e.g., devices and modules (components)) regardless of whether or not all the constituent elements are included in the same housing. Therefore, a plurality of devices connected through a network, the devices each being housed in a different housing, and one device including a plurality of modules housed in one housing, are involved all in the system.

Note that an embodiment of the present technology is not limited to the embodiments described above, and thus various alterations may be made without departing from the scope of the spirit of the present technology.

For example, an aspect of the present technology can have a configuration of cloud computing in which a plurality of devices shares one function through a network and performs processing in cooperation.

Furthermore, each step described in the above flowchart can be shared and performed by a plurality of devices, in addition to being performed by one device.

Moreover, in a case where one step includes a plurality of pieces of processing, the plurality of pieces of processing included in the one step can be shared and performed by a plurality of devices, in addition to being performed by one device.

Furthermore, the effects described in the present specification are not limitative, and thus additional effects may be provided.

Note that the present technology can have the following configurations.

<1>

An image processing device including:

a stroboscopic model generation unit configured to generate a stroboscopic model in which 3D models of a subject at a plurality of times generated from a plurality of viewpoint images captured from a plurality of viewpoints, are arranged in a three-dimensional space; and

a camerawork setting unit configured to set camerawork of a virtual camera for generation of a stroboscopic image by capturing of the stroboscopic model by the virtual camera, in accordance with a state of the 3D models arranged in the stroboscopic model.

<2>

The image processing device according to <1>, in which the camerawork includes a capturing position and an attitude of the virtual camera that captures the stroboscopic model.

<3>

The image processing device according to <1> or <2>, in which

a frame of the stroboscopic image is generated for each of the capturing positions.

<4>

The image processing device according to any one of <1> to <3>, in which

the camerawork setting unit sets the camerawork, in accordance with a model distribution of the 3D models arranged in the stroboscopic model.

<5>

The image processing device according to any one of <1> to <4>, in which

the camerawork setting unit sets the camerawork, in accordance with a trajectory of the 3D models arranged in the stroboscopic model.

<6>

The image processing device according to any one of <1> to <5>, in which

the camerawork setting unit sets a capturing position of the virtual camera sparser on a capturing route that is not a parallel capturing route including a capturing route along the trajectory of the 3D models arranged in the stroboscopic model, than on the parallel capturing route.

<7>

The image processing device according to any one of <1> to <6>, in which

the camerawork setting unit sets a capturing start position and a capturing finish position of the virtual camera, in accordance with the model distribution.

<8>

The image processing device according to any one of <1> to <7>, in which

the camerawork setting unit sets the capturing start position and the capturing finish position of the virtual camera, in accordance with a trajectory of the 3D models arranged in the stroboscopic model.

<9>

The image processing device according to any one of <1> to <8>, in which

the camerawork setting unit sets a position in a direction perpendicular to the trajectory of the 3D models, as the capturing start position of the virtual camera.

<10>

The image processing device according to any one of <1> to <9>, in which

the camerawork setting unit sets the capturing position on a surrounding line that surrounds all the 3D models arranged in the stroboscopic model.

<11>

The image processing device according to any one of <1> to <10>, in which

the camerawork setting unit sets the camerawork for the stroboscopic model in which the 3D models of the subject that is an animal are arranged, in accordance with a face of the animal.

<112>

The image processing device according to any one of <1> to <11>, in which

the camerawork setting unit sets the capturing position and the attitude such that the stroboscopic model is captured in a direction facing the face of the animal.

<13>

The image processing device according to any one of <1> to <12>, in which

the camerawork setting unit sets a position and an attitude of a camera having captured the plurality of viewpoint images as a capturing start position or a capturing finish position of the virtual camera and the attitude of the virtual camera at the capturing start position or the capturing finish position.

<14>

The image processing device according to any one of <1> to <13>, in which

the camerawork setting unit changes the camerawork, in accordance with an operation of a user, with restriction of movement of the virtual camera for an x axis, a y axis, or a z axis.

<15>

The image processing device according to any one of <1> to <14>, in which

the camerawork setting unit selects the 3D models to be arranged in the stroboscopic model, in accordance with the state of the 3D models arranged in the stroboscopic model viewed from the virtual camera.

<16>

The image processing device according to any one of <1> to <15>, in which

the camerawork setting unit selects at least a 3D model that is not a 3D model on a far side overlapping a 3D model on a front side when viewed from the virtual camera, as a 3D model to be arranged in the stroboscopic model.

<17>

The image processing device according to any one of <1> to <16>, further including: a model selection unit configured to select the 3D models to be arranged in the stroboscopic model, in accordance with an operation of a user.

<18>

The image processing device according to any one of <1> to <17>, in which

the model selection unit selects part of the 3D models arranged in the stroboscopic model generated by the stroboscopic model generation unit, and generates the stroboscopic model in which the selected part of the 3D models is arranged.

<19>

An image processing method including:

generating a stroboscopic model in which 3D models of a subject at a plurality of times generated from a plurality of viewpoint images captured from a plurality of viewpoints, are arranged in a three-dimensional space; and

setting camerawork of a virtual camera for generation of a stroboscopic image by capturing of the stroboscopic model by the virtual camera, in accordance with a state of the 3D models arranged in the stroboscopic model.

<20>

A program for causing a computer to function as:

a stroboscopic model generation unit configured to generate a stroboscopic model in which 3D models of a subject at a plurality of times generated from a plurality of viewpoint images captured from a plurality of viewpoints, are arranged in a three-dimensional space; and

a camerawork setting unit configured to set camerawork of a virtual camera for generation of a stroboscopic image by capturing of the stroboscopic model by the virtual camera, in accordance with a state of the 3D models arranged in the stroboscopic model.

<21>

An image processing device including: circuitry configured to:

generate a stroboscopic model including 3D models of a subject arranged in a three-dimensional space, the 3D models being generated from a plurality of viewpoint images captured from a plurality of viewpoints at a plurality of times; and

set camerawork of a virtual camera in accordance with a state of the 3D models arranged in the stroboscopic model, the camerawork being set for capturing the stroboscopic model by the virtual camera to generate a stroboscopic image.

<22>

The image processing device according to <21>, wherein the camerawork includes capturing positions and attitudes at which the virtual camera captures the stroboscopic model.

<23>

The image processing device according to <21> or <22>, wherein

a frame of the stroboscopic image is generated for each of the capturing positions.

<24>

The image processing device according to any one of <21> to <23>, wherein the circuitry is further configured to: set the camerawork in accordance with a model distribution of the 3D models arranged in the stroboscopic model.

<25>

The image processing device according to any one of <21> to <24>, wherein the circuitry is further configured to: set the camerawork in accordance with a trajectory of the 3D models arranged in the stroboscopic model.

<26>

The image processing device according to any one of <21> to <25>, wherein the circuitry is further configured to: set a density of capturing positions of the virtual camera on a capturing route that is a parallel capturing route including a capturing route along the trajectory of the 3D models arranged in the stroboscopic model to a density that is greater than a density of capturing positions of the virtual camera on a capturing route that is not the parallel capturing route.

<27>

The image processing device according to any one of <21> to <26>, wherein the circuitry is further configured to:

set, in accordance with the model distribution, a capturing start position and a capturing finish position of the virtual camera.

<28>

The image processing device according to any one of <21> to <27>, wherein the circuitry is further configured to:

set, in accordance with a trajectory of the 3D models, the capturing start position and the capturing finish position of the virtual camera.

<29>

The image processing device according to any one of <21> to <28>, wherein the circuitry is further configured to:

set, as the capturing start position of the virtual camera, a position in a direction perpendicular to the trajectory of the 3D models.

<30>

The image processing device according to any one of <21> to <29>, wherein the circuitry is further configured to:

set the capturing positions on a surrounding line that surrounds all the 3D models arranged in the stroboscopic model.

<31>

The image processing device according to any one of <21> to <30>, wherein the subject is an animal, and

wherein the circuitry is further configured to:

set the camerawork for the stroboscopic model in accordance with a face of the animal.

<32>

The image processing device according to any one of <21> to <31>, wherein the circuitry is further configured to:

set the capturing positions and the attitudes such that the stroboscopic model is captured in a direction facing the face of the animal.

<33>

The image processing device according to any one of <21> to <32>, wherein the circuitry is further configured to:

set a position of a camera having captured the plurality of viewpoint images as a capturing start position or a capturing finish position of the virtual camera; and

set an attitude of the camera having captured the plurality of viewpoint images as the attitude of the virtual camera at the capturing start position or the capturing finish position.

<34>

The image processing device according to any one of <21> to <33>, wherein the circuitry is further configured to:

change the camerawork, in accordance with an operation of a user, by moving a position or an attitude of the virtual camera with restriction of the movement of the virtual camera around an x axis, a y axis, or a z axis.

<35>

The image processing device according to any one of <21> to <34>, wherein the circuitry is further configured to:

select, in accordance with the state of the 3D models arranged in the stroboscopic model viewed from the virtual camera, the 3D models to be arranged in the stroboscopic model.

<36>

The image processing device according to any one of <21> to <35>, wherein the circuitry is further configured to:

select, in accordance with a degree of overlapping of the 3D models, a 3D model to be arranged in the stroboscopic model.

<37>

The image processing device according to any one of <21> to <36>, wherein the circuitry is further configured to:

select, in accordance with an operation of a user and from among all of the 3D models in the stroboscopic model, the 3D models to be arranged in the stroboscopic model

<38>

The image processing device according to any one of <21> to <37>, wherein the circuitry is further configured to:

select part of the 3D models arranged in the stroboscopic model; and

generate the stroboscopic model in which the selected part of the 3D models is arranged,

wherein the selected part of 3D models is fewer in number than all of the 3D models.

<39>

An image processing method including:

generating a stroboscopic model including 3D models of a subject arranged in a three-dimensional space, the 3D models being generated from a plurality of viewpoint images captured from a plurality of viewpoints at a plurality of times; and

setting camerawork of a virtual camera in accordance with a state of the 3D models arranged in the stroboscopic model, the camerawork being set for capturing the stroboscopic model by the virtual camera to generate a stroboscopic image.

<40>

A non-transitory computer-readable medium having embodied thereon a program, which when executed by a computer causes the computer to execute an imaging processing method, the method including:

generating a stroboscopic model including 3D models of a subject arranged in a three-dimensional space, the camerawork being set for capturing the stroboscopic model by the virtual camera to generate a stroboscopic image; and

setting camerawork of a virtual camera in accordance with a state of the 3D models arranged in the stroboscopic model, the camerawork being for capturing the stroboscopic model by the virtual camera to generate a stroboscopic image.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

11 Image capturing unit
12 Free viewpoint data generation unit
13 Image processing unit
14 Free viewpoint image generation unit
15 Display unit
21 Stroboscopic model generation unit
22 Model selection unit
23 Effect processing unit
24 Camerawork setting unit
25 Overlay image processing unit
31 Display portion
32 Operation portion
41 Display portion
42 Operation portion
61 Position setting unit
62 Camerawork generation unit
63 Camerawork storage unit
901 Bus
902 CPU
903 ROM
904 RAM
905 Hard disk
906 Output unit
907 Input unit
908 Communication unit
909 Drive
910 Input/output interface
911 Removable recording medium

1. An image processing device comprising:
circuitry configured to:
generate a stroboscopic model including 3D models of a subject arranged in a three-dimensional space, the 3D models being generated from a plurality of viewpoint images captured from a plurality of viewpoints at a plurality of times; and
set camerawork of a virtual camera in accordance with a state of the 3D models arranged in the stroboscopic model, the camerawork being set for capturing the stroboscopic model by the virtual camera to generate a stroboscopic image.

2. The image processing device according to claim 1, wherein
the camerawork includes capturing positions and attitudes at which the virtual camera captures the stroboscopic model.

3. The image processing device according to claim 2, wherein
a frame of the stroboscopic image is generated for each of the capturing positions.

4. The image processing device according to claim 1, wherein the circuitry is further configured to:
set the camerawork in accordance with a model distribution of the 3D models arranged in the stroboscopic model.

5. The image processing device according to claim 4, wherein the circuitry is further configured to:
set the camerawork in accordance with a trajectory of the 3D models arranged in the stroboscopic model.

6. The image processing device according to claim 5, wherein the circuitry is further configured to:
set a density of capturing positions of the virtual camera on a capturing route that is a parallel capturing route including a capturing route along the trajectory of the 3D models arranged in the stroboscopic model to a density that is greater than a density of capturing positions of the virtual camera on a capturing route that is not the parallel capturing route.

7. The image processing device according to claim 4, wherein the circuitry is further configured to:
set, in accordance with the model distribution, a capturing start position and a capturing finish position of the virtual camera.

8. The image processing device according to claim 7, wherein the circuitry is further configured to:
set, in accordance with a trajectory of the 3D models, the capturing start position and the capturing finish position of the virtual camera.

9. The image processing device according to claim 8, wherein the circuitry is further configured to:
set, as the capturing start position of the virtual camera, a position in a direction perpendicular to the trajectory of the 3D models.

10. The image processing device according to claim 2, wherein the circuitry is further configured to:
set the capturing positions on a surrounding line that surrounds all the 3D models arranged in the stroboscopic model.

11. The image processing device according to claim 2, wherein the subject is an animal, and
wherein the circuitry is further configured to:
set the camerawork for the stroboscopic model in accordance with a face of the animal.

12. The image processing device according to claim 11, wherein the circuitry is further configured to:
set the capturing positions and the attitudes such that the stroboscopic model is captured in a direction facing the face of the animal.

13. The image processing device according to claim 2, wherein the circuitry is further configured to:
set a position of a camera having captured the plurality of viewpoint images as a capturing start position or a capturing finish position of the virtual camera; and
set an attitude of the camera having captured the plurality of viewpoint images as the attitude of the virtual camera at the capturing start position or the capturing finish position.

14. The image processing device according to claim 1, wherein the circuitry is further configured to:
change the camerawork, in accordance with an operation of a user, by moving a position or an attitude of the virtual camera with restriction of the movement of the virtual camera around an x axis, a y axis, or a z axis.

15. The image processing device according to claim 1, wherein the circuitry is further configured to:
select, in accordance with the state of the 3D models arranged in the stroboscopic model viewed from the virtual camera, the 3D models to be arranged in the stroboscopic model.

16. The image processing device according to claim 15, wherein the circuitry is further configured to:
select, in accordance with a degree of overlapping of the 3D models, a 3D model to be arranged in the stroboscopic model.

17. The image processing device according to claim 1, wherein the circuitry is further configured to:
select, in accordance with an operation of a user and from among all of the 3D models in the stroboscopic model, the 3D models to be arranged in the stroboscopic model

18. The image processing device according to claim 17, wherein the circuitry is further configured to:
select part of the 3D models arranged in the stroboscopic model; and
generate the stroboscopic model in which the selected part of the 3D models is arranged,
wherein the selected part of 3D models is fewer in number than all of the 3D models.

19. An image processing method comprising:
generating a stroboscopic model including 3D models of a subject arranged in a three-dimensional space, the 3D models being generated from a plurality of viewpoint images captured from a plurality of viewpoints at a plurality of times; and
setting camerawork of a virtual camera in accordance with a state of the 3D models arranged in the stroboscopic model, the camerawork being set for capturing the stroboscopic model by the virtual camera to generate a stroboscopic image.

20. A non-transitory computer-readable medium having embodied thereon a program, which when executed by a computer causes the computer to execute an imaging processing method, the method comprising:
generating a stroboscopic model including 3D models of a subject arranged in a three-dimensional space, the camerawork being set for capturing the stroboscopic model by the virtual camera to generate a stroboscopic image; and
setting camerawork of a virtual camera in accordance with a state of the 3D models arranged in the stroboscopic model, the camerawork being for capturing the stroboscopic model by the virtual camera to generate a stroboscopic image.
